(19) United States
(12) Patent Application Publication
(10) Pub. No.: US 2012/0279497 A1
(43) Pub. Date: Nov. 8, 2012

(54) VISCOUS CARBOHYDRATE COMPOSITIONS AND METHODS FOR THE PRODUCTION THEREOF

(75) Inventors: Robert Jansen, Collinsville, IL (US); Aharon Eyal, Jerusalem (IL)

(73) Assignee: Virdia Ltd, Herzelia (IL)

(21) Appl. No.: 13/491,485

(22) Filed: Jun. 7, 2012

Related U.S. Application Data
(63) Continuation-in-part of application No. PCT/IL2010/001042, filed on Dec. 9, 2010.
Application No. PCT/IL2010/001042 is a continuation-in-part of application No. PCT/IL2011/000304, filed on Apr. 13, 2011.
(60) Provisional application No. 61/472,681, filed on Apr. 7, 2011.

(30) Foreign Application Priority Data
Dec. 9, 2009 (IL) IL 202631
Dec. 10, 2009 (IL) IL 202683
May 9, 2010 (IL) IL 205617
Dec. 8, 2010 (IL) IL 209845

(51) Int. Cl. C13K 13/00

(52) U.S. Cl. 127/29; 127/34; 127/36

(57) ABSTRACT

A viscous fluid comprising 2% wt to 25% wt water, at least 75% wt carbohydrate (calculated by 100×[carbohydrate/(carbohydrate weight+water weight)]), between 0% wt and 25% wt of a second organic solvent and between 10% wt and 55% wt HCl (calculated by 100×[HCl weight/HCl weight+water weight]), which second organic solvent is characterized by at least one of: (a2) having a polarity related component of Hoy's cohesion parameter between 0 and 15 MPa^{1/2}; (b2) having a Hydrogen bonding related component of Hoy's cohesion parameter between 0 and 20 MPa^{1/2}; and (c2) having a solubility in water of less than 15% and forming a heterogeneous azeotrope with water, wherein the weight/weight ratio of said second organic solvent to water is in the range of between 50 and 0.02, and wherein the solubility of water in said organic solvent is less than 20%.

### CROSS-REFERENCE

This application is a continuation-in-part of International Patent Application PCT/IL2010/001042, filed Dec. 9, 2010, which claims priority to Israeli Patent Application IL202,631, filed Dec. 9, 2009, to Israeli Patent Application IL202,683, filed Dec. 10, 2009, and to Israeli Patent Application IL209,845, filed Dec. 8, 2010; and a continuation-in-part of International Patent Application PCT/IL2011/000304, filed Apr. 13, 2011, which claims priority to Israeli Patent Application IL205,617, filed May 9, 2010, and to U.S. Provisional Application 61/472,681, filed Apr. 7, 2011, each of which is incorporated by reference herein in its entirety.

### FIELD OF THE INVENTION

The invention relates to novel viscous carbohydrate compositions, to methods for the production thereof, and to methods for processing lignocellulosic materials for producing said novel viscous carbohydrate compositions therefrom as well as to the production of further useful products.

### BACKGROUND

The carbohydrates-conversion industry is large and increases rapidly. Thus, nearly 100 million tons of carbohydrates are fermented annually to fuel-grade ethanol and this number is expected to triple in the next decade. Millions of tons of carbohydrates are also fermented every year into food and feed products, such as citric acid and lysine. Fermentation to industrial products is also increasing, such as the production of monomers for the polymer industry, e.g. lactic acid for the production of polylactide. Carbohydrates are an attractive and environmental-friendly substrate since they are obtained from renewable resources, such as sucrose from sugar canes and glucose from corn and wheat starches. Such renewable resources are limited in volume and increased consumption is predicted to increase food costs. There is therefore a strong motivation to generate carbohydrates from renewable non-food resources. It is particularly desired to produce such carbohydrates at costs that are lower than those of the food carbohydrates. Low cost carbohydrates will open the way for much greater production of biofuels and industrial products, such as monomers. Thus, new processes are being developed for the production of alternative fuels such as fatty acid esters and hydrocarbons which can be directly formed by fermentation or produced by conversion of fermentation products. The majority of the future production from carbohydrates will use fermentation, but chemical conversion of carbohydrates also seems attractive.

An abundant and relatively-low cost source of carbohydrates is woody material, such as wood and co-products of wood processing and residues of processing agricultural products, e.g. corn stover and cobs, sugar cane bagasse and empty fruit bunches from palm oil production. There is also the potential of growing for that purpose switch grass and other “energy crops” that generate low-cost rapid growing biomass. Such carbohydrate sources contain as their main components cellulose, hemicellulose and lignin and are also referred to as lignocellulosic material. Such material also contains mineral salts, ashes, and organic compounds, such as tall oils. Cellulose and hemicellulose, which together form 65-80% of the lignocellulosic material, are polysaccharides and their hydrolysis forms carbohydrates suitable for fermentation and chemical conversion to products of interest. Hydrolysis of hemicellulose is relatively easy, but that of cellulose, which typically forms more than one half of the polysaccharides content, is difficult due to its crystalline structure. Presently known methods for converting lignocellulosic material to carbohydrates involve enzymatic-catalyzed and/or acid-catalyzed hydrolysis. In many cases, pre-treatments are involved, e.g. lignin and/or hemicellulose extraction, steam or ammonia explosion, etc. The known technologies are still too expensive and there is a strong need for alternative, lower-cost ones. In addition, carbohydrates cost could be lowered by valorizing co-products such as lignin and tall oils. There is therefore a need for technology that, in addition to using low-cost hydrolysis, generates those co-products at high quality.

Acid hydrolysis of lignocellulosic material was considered and tested as a pre-treatment for enzymatic hydrolysis. Alternatively, acid could be used as the sole hydrolysis catalyst, obviating the need for high-cost enzymes. Most of the efforts focused on sulfuric acid and hydrochloric acid (HCl), with preference for the latter. In fact, HCl-based hydrolysis of lignocellulosic material, using no enzymes, was implemented on an industrial scale. Such hydrolysis forms a hydrolyzate stream containing the carbohydrate products, other soluble components of the lignocellulosic material and HCl. Since the lignin fraction of the material does not hydrolyze and stays essentially insoluble, the process also forms a co-product stream containing the lignin dispersed in or wetted by an aqueous solution of HCl.

Since HCl acts as a catalyst, it is not consumed in the process. It should be separated from the hydrolysis products and co-products and recycled for re-use. Such separation and recycle presents many challenges, some of which are listed in the following. Thus, the recovery yield needs to be high in order to minimize costs related to acid losses, to consumption of a neutralizing base and to disposal of the formed salt. In addition, residual acid content of the product and the co-products should be low in order to enable their optimal use. Acid recovery from the hydrolyzate should be conducted in conditions i.e. mainly temperature, minimizing thermal and HCl-catalyzed carbohydrates degradation. Recovery of HCl from lignin co-product stream is complicated by the need to deal with solids and by the need to form HCl-free lignin. The literature suggests washing HCl off the lignin, but the amount of water required is large, the wash solution is therefore dilute and recycle to hydrolysis requires re-concentration at high cost. Another major challenge is related to the concentration of the separated and recovered acid. For high yield hydrolysis of the cellulosic fraction of the lignocellulosic material, concentrated HCl is required, typically greater than 40%. Thus, the recovered acid is optionally obtained at that high concentration in order to minimize re-concentration costs.

Still another challenge is related to the fact that HCl forms an azeotrope with water. Since HCl is volatile, recovery from HCl solutions by distillation is attractive in a generating gaseous, nearly dry HCl stream. Yet, due to the formation of the azeotrope, such distillation is limited to removing HCl down to azeotropic concentration which is about 20%, depending on the conditions. Further removal of HCl requires co-distillation with water to form a vapor phase wherein HCl concentration is about 20%. Therefore, in order to achieve complete removal of the acid from the carbohydrate, distillation to dryness would be required. Alternatively, addition of water, or steam stripping, dilutes the residual acid to below the azeotropic concentration. As a result, mainly water evaporates, i.e. the residual HCl is obtained in a highly dilute HCl stream, which then entails high re-concentration costs. Furthermore, studies of such removal have concluded that steam stripping cannot achieve full removal of the acid. K. Schoenemann in his presentation entitled “The New Rheinau Wood Saccharification Process” to the Congress of Food and Agricultural Organization of The United Nations at Stockholm in July 1953 reviewed the concentrated HCl-based processes and the related physical properties data. His conclusion was: “as the boiling line . . . demonstrates, it is not possible to distill the hydrogen chloride completely from the sugar solution by a simple distillation, not even by spray-distillation, as it was attempted formerly. Thus, the hydrochloric acid could be removed in a post-evaporation down to 3.5%, calculated on sugars by injecting steam, which acts like alternating diluting and distilling.” Such amount of residual HCl in the carbohydrates is industrially unacceptable.

In addition, HCl removal from highly concentrated carbohydrate solutions is complicated by the high viscosity of the formed streams. Some efforts were made in the past to remove the residual acid by spray drying the hydrolyzate. Based on various studies, spray drying cannot achieve complete removal of the acid. Such incomplete removal of the acid decreases recovery yield and requires neutralization in the product or indirectly on an ion-exchanger. In addition, since the feed to the spray drier should be fluid, the amount of water and HCl removed by distillation from the hydrolyzate is limited. According to F. Bergius, the developer of the HCl-hydrolysis technology, in his publication “Conversion of wood to carbohydrates and problems in the industrial use of concentrated hydrochloric acid” published in Industrial and Engineering Chemistry (1937), 29, 247-53, 80% of the HCl can be removed by evaporation prior to spray drying. Thus, large amounts of water and HCl should be removed in the spray drier, which increases both the capital and the operating cost of such a process.

In latter developed technologies, a fraction of the acid in the hydrolyzate is distilled out as a gaseous, nearly dry HCl, to reach azeotropic concentration. Optionally, another fraction of the acid is distilled as gas of azeotropic composition. Then, the residual acid is removed by alternative, non-distillative means, such as crystallization, membrane separation and solvent extraction by various solvents. The assignee of the present application has several co-pending patent applications in which an acid-base couple extractant is used for that purpose. Solvent extraction was found to fully remove the residual acid, but at a relatively high equipment cost and with the need for special operations to avoid extractant losses and product contamination by the extractant.

An object of some embodiments of the invention is to provide a method for high yield recovery of HCl from the products and co-products of HCl hydrolysis of lignocellulosic material. A related object is to recover that acid at high concentration to minimize re-concentration needs. Another object is to produce carbohydrates and co-products of high quality that are essentially free of HCl. Still another object is to form a carbohydrate composition with minimal moisture and HCl contents that is fluid enough for low-cost spray-drier based removal of residual HCl.

### SUMMARY OF THE INVENTION

One aspect of some embodiments of the invention relates to a viscous fluid comprising between 2% wt and 25% wt water at least 75% wt carbohydrate, as calculated by 100 times carbohydrate weight divided by the combined weights of the carbohydrate and water, between 0% wt and 25% wt of a second organic solvent and between 10% wt and 55% wt HCl, as calculated by 100 time HCl weight divided by the combined weights of HCl and water, which second organic solvent is characterized by at least one of:

(a2) having a polarity related component of Hoy's cohesion parameter between 0 and 15 MPa^{1/2};

(b2) having a hydrogen bonding related component of Hoy's cohesion parameter between 0 and 20 MPa^{1/2}; and

(c2) having a solubility in water of less than 15%, and forming a heterogeneous azeotrope with water, wherein the weight/weight ratio of said second organic solvent to water is in the range of between 50 and 0.02, and wherein the solubility of water in said organic solvent is less than 20%.

According to an embodiment, the viscous fluid viscosity as measured at 80° C. by the Brookfield method is less than 150 cP. According to various embodiments, in said viscous fluid the HCl/water weight/weight ratio is in the range between 0.2 and 1.0, the carbohydrate/water weight/weight ratio is in the range between 2 and 20, and the HCl/carbohydrate weight/weight ratio is in the range between 0.02 and 0.15.

According to an embodiment, the second organic solvent/water weight/weight ratio in said viscous fluid is R2, wherein the second organic solvent forms a heterogeneous azeotrope with water and the second organic solvent/water weight/weight ratio in said azeotrope is R22 and wherein R2 is greater than R22 by at least 10%.

According to another embodiment, the second organic solvent forms a heterogeneous azeotrope with water, wherein said second organic solvent has a boiling point at 1 atm in the range between 100° C. and 200° C. and wherein said heterogeneous azeotrope has a boiling point at 1 atm of less than 100° C.

According to another embodiment, said viscous fluid is maintained under a pressure of less than 400 mbar.

According to an embodiment the viscous fluid comprises glucose and at least one carbohydrate selected from the group consisting of mannose, galactose, xylose, arabinose, and fructose, optionally the viscous fluid comprises at least two carbohydrates selected from the group consisting of mannose, galactose, xylose, arabinose and fructose.

Some exemplary embodiments of the invention provide, a viscous fluid consisting essentially of: between 2% wt and 25% wt water, at least 75% wt carbohydrate, as calculated by 100 times carbohydrate weight divided by the combined weights of the carbohydrate and water, between 0% wt and 25% wt of a second organic solvent and between 10% wt and 55% wt HCl, as calculated by 100 time HCl weight divided by the combined weights of HCl and water, which second organic solvent is characterized by at least one of: (a2) having a polarity related component of Hoy's cohesion parameter between 0 and 15 MPa^{1/2}; (b2) having a hydrogen bonding related component of Hoy's cohesion parameter between 0 and 20 MPa^{1/2}; and (c2) having a solubility in water of less than 15% and forming a heterogeneous azeotrope with water, wherein the weight/weight ratio of said second organic solvent to water is in the range of between 50 and 0.02, and wherein the solubility of water in said organic solvent is less than 20%.

Another aspect of some embodiments of the invention relates to a method for the deacidification of a first aqueous solution comprising the steps of:

(i) providing a first aqueous solution comprising carbohydrates, HCl and water, wherein the weight/weight ratio of carbohydrates to water is in the range of between 0.4 and 3 and wherein the weight/weight ratio of HCl to water is in the range between 0.17 and 0.50;

(ii) contacting said first aqueous solution with a second organic solvent to form a second evaporation feed, which second organic solvent forms a heterogeneous azeotrope with water and is characterized by at least one of

(a2) having a polarity related component of Hoy's cohesion parameter between 0 and 15 MPa^{1/2}.

(b2) having a hydrogen bonding related component of Hoy's cohesion parameter between 0 and 20 MPa^{1/2}; and

(c2) having a solubility in water of less than 15%, and forming a heterogeneous azeotrope with water wherein the weight/weight ratio of said second organic solvent to water is in the range of between 50 and 0.02, and wherein the solubility of water in said organic solvent is less than 20% and

(iii) evaporating water, HCl and a second organic solvent from said second evaporation feed at a temperature below 100° C. and at a pressure below 1 atm,

whereupon a second vapor phase and a viscous fluid as described above are formed.

According to an embodiment, providing said first aqueous solution comprises hydrolyzing a polysaccharide-comprising material in an HCl-comprising hydrolysis medium, wherein HCl concentration is greater than azeotropic.

According to another embodiment, the weight/weight ratio of said second organic solvent to water in said second evaporation feed is R23, wherein the weight/weight ratio of said second organic solvent to water in said azeotrope is R22 and wherein R23 is greater than R22 by at least 10%.

According to another embodiment, the method further comprises the steps of condensing the vapors in said second vapor phase to form two phases, a second organic solvent-rich one and a first water-rich one, separating said phases, using said second organic solvent-rich phase in step (ii), and using said first water-rich phase for generating said hydrolysis medium.

According to another embodiment, said viscous solution comprises carbohydrate oligomers and the method further comprises the steps of diluting said viscous fluid to form oligomers and an HCl-comprising diluted fluid, and maintaining said HCl-comprising diluted fluid at a temperature and for a residence time sufficient for the hydrolysis of at least 50% of said oligomers.

According to another embodiment, the method further comprises the steps of diluting said viscous fluid to form the HCl-comprising diluted fluid, and separating HCl from said HCl-comprising diluted fluid by means selected from solvent extraction, membrane separation, ion-exchange and combinations thereof to form a de-acidified carbohydrates solution.

According to another embodiment, the method further comprises the steps of diluting said viscous fluid to form the HCl-comprising diluted fluid, neutralizing at least a fraction of said HCl to form a diluted fluid comprising a chloride salt and carbohydrates, and separating said salt from said carbohydrates by means selected from membrane separation and chromatography to form a de-acidified carbohydrates solution.

According to an embodiment, the weight/weight ratio of HCl to carbohydrates in said de-acidified carbohydrate solution is less than 0.03.

Another aspect of some embodiments of the invention relates to a lignin composition comprising between 10% wt and 50% wt lignin, less than 8% wt water, between 50% wt and 90% wt of a first organic solvent and less than 10% HCl (on an as is basis), which first organic solvent is characterized by at least one of:

(a1) having a polarity related component of Hoy's cohesion parameter between 0 and 15 MPa^{1/2};

(b1) having a Hydrogen bonding related component of Hoy's cohesion parameter between 0 and 20 MPa^{1/2}; and

(c1) having a solubility in water of less than 15%, and forming a heterogeneous azeotrope with water wherein the weight/weight ratio of the first organic solvent to water is in the range of between 5 and 0.2, and wherein the solubility of water in the organic solvent is less than 20%

According to an embodiment, the lignin composition further comprises at least one carbohydrate and wherein the concentration of the carbohydrate is less than 5% wt.

According to another embodiment, in the lignin composition, the weight/weight ratio of the first organic solvent to water is R1, wherein the first organic solvent forms a heterogeneous azeotrope with water, wherein the weight/weight ratio of the first organic solvent to water in the azeotrope is R12 and wherein R1 is greater than R12 by at least 10%.

According to another embodiment, the first organic solvent forms a heterogeneous azeotrope with water, wherein the first organic solvent has a boiling point at 1 atm in the range between 100° C. and 200° C. and wherein the heterogeneous azeotrope has a boiling point at 1 atm of less than 100° C.

Another aspect of some embodiments of the invention relates to a method for the deacidification of a second lignin stream comprising the steps of

(i) providing a second lignin stream comprising lignin, HCl and water, wherein the weight/weight ratio of lignin to water is in the range between 0.1 and 2 and wherein the weight/weight ratio of HCl to water is in the range between 0.15 and 1;

(ii) contacting the second lignin stream with a first organic solvent to form a first evaporation feed, which first organic solvent forms with water a heterogeneous azeotrope and is characterized by at least one of

(a1) having a polarity related component of Hoy's cohesion parameter between 0 and 15 MPa^{1/2};

(b1) having a Hydrogen bonding related component of Hoy's cohesion parameter between 0 and 20 MPa^{1/2}; and

(c1) having a solubility in water of less than 15%, and forming a heterogeneous azeotrope with water wherein the weight/weight ratio of the first organic solvent to water is in the range of between 5 and 0.2, and wherein the solubility of water in the organic solvent is less than 20%; and

(iii) evaporating water, HCl and the first organic solvent from the first evaporation feed at a temperature below 100° C. and at a pressure below 1 atm, whereupon a first vapor phase and a lignin composition as defined hereinbefore, are formed.

According to an embodiment, providing the second lignin stream comprises hydrolyzing a lignocellulosic material in an HCl-comprising hydrolysis medium, wherein HCl concentration is greater than azeotropic.

According to an embodiment, the weight/weight ratio of the first organic solvent to water in the first evaporation feed is R13, wherein the weight/weight ratio of the first organic solvent/water in the azeotrope is R12 and wherein R13 is greater than R12 by at least 10%.

According to another embodiment, the method further comprises the steps of condensing the vapors in the first vapor phase to form two phases, a first organic solvent-rich one and a second water-rich one, separating the phases, and using the first organic solvent-rich phase in step (ii).

Another aspect of some embodiments of the invention relates to a method for the production of a carbohydrate composition comprising

(i) providing a lignocellulosic material feed comprising a polysaccharide and lignin;

(ii) hydrolyzing said polysaccharide in an HCl-comprising hydrolysis medium to form a first aqueous solution comprising carbohydrates, HCl and water, wherein the weight/weight ratio of carbohydrates to water is in the range of between 0.4 and 3 and wherein the weight/weight ratio of HCl to water is in the range between 0.17 and 0.50

(iii) contacting said first aqueous solution with a second organic solvent to form a second evaporation feed, which second organic solvent forms with water a heterogeneous azeotrope and is characterized by at least one of:

(a2) having a polarity related component of Hoy's cohesion parameter between 0 and 15 MPa^{1/2}.

(b2) having a Hydrogen bonding related component of Hoy's cohesion parameter between 0 and 20 MPa^{1/2}; and

(c2) having a solubility in water of less than 15%, and forming a heterogeneous azeotrope with water wherein the weight/weight ratio of the second organic solvent to water is in the range of between 5 and 0.2, and wherein the solubility of water in the organic solvent is less than 20%; and

(iv) evaporating water, HCl and a second organic solvent from the second evaporation feed at a temperature below 100° C. and at a pressure below 1 atm, whereupon a second vapor phase and a viscous fluid as defined hereinbefore, are formed.

According to an embodiment, the weight/weight ratio of the second organic solvent to water in the second evaporation feed is R23, wherein the weight/weight ratio of the second organic solvent to water in the azeotrope is R22 and wherein R23 is greater than R22 by at least 10%.

According to another embodiment, the method further comprises the steps of condensing the vapors in the second vapor phase to form two phases, a second organic solvent-rich one and a first water-rich one, separating the phases, using the second organic solvent-rich phase in step (iii), and using the first water-rich phase for generating the hydrolysis medium.

According to an embodiment, the method further comprises the step of spray drying the viscous fluid to form a de-acidified solid carbohydrate composition. According to a related embodiment, the weight/weight ratio of HCl to carbohydrates in the de-acidified solid carbohydrate composition is less than 0.03.

According to another embodiment, the hydrolyzing forms a hydrolyzate, wherein forming the first aqueous solution comprises separating a portion of the HCl from the hydrolyzate to form a first separated HCl stream and an HCl-depleted hydrolyzate and wherein the first separated HCl stream is used for generating the hydrolysis medium.

According to still another embodiment the amount, the purity and the concentration of HCl in the hydrolyzate are W4, P4 and C4, respectively and the amount, the purity and the concentration of HCl in the first separated HCl stream are W5, P5 and C5, respectively and wherein W5/W4 is greater than 0.1, P5/P4 is greater than 1.8, and C5/C4 is greater than 1.8.

According to a related embodiment, the method further comprises the steps of separating another portion of HCl from the HCl-depleted hydrolyzate to form a second separated HCl stream and using the second separated HCl stream for generating the hydrolysis medium.

According to a related embodiment, the amount, the purity and the concentration of HCl in the second separated HCl stream are W7, P7 and C7, respectively and wherein W7/W4 is greater than 0.1, P7/P4 is greater than 1.8, and C7/C4 is greater than 0.4.

One aspect of some embodiments of the invention relates to a method for the production of lignin comprising

(i) providing a lignocellulosic material feed comprising a polysaccharide and lignin;

(ii) hydrolyzing the polysaccharide in an HCl-comprising hydrolysis medium to form a second lignin stream comprising lignin, HCl and water, wherein the weight/weight ratio of lignin to water is in the range between 0.1 and 2 and wherein the weight/weight ratio of HCl to water is in the range between 0.15 and 1;

(iii) contacting the second lignin stream with a first organic solvent to form a first evaporation feed, which first organic solvent forms with water a heterogeneous azeotrope and is characterized by at least one of:

(a1) having a polarity related component of Hoy's cohesion parameter between 0 and 15 MPa^{1/2}.

(b1) having a Hydrogen bonding related component of Hoy's cohesion parameter between 0 and 20 MPa^{1/2}; and

(c1) having a solubility in water of less than 15%, and forming a heterogeneous azeotrope with water wherein the weight/weight ratio of the first organic solvent to water is in the range of between 5 and 0.2, and wherein the solubility of water in the organic solvent is less than 20% and

(iv) evaporating water, HCl and the first organic solvent from the first evaporation feed at a temperature below 100° C. and at a pressure below 1 atm, whereupon a first vapor phase and a lignin composition as defined hereinbefore, are formed.

According to an embodiment, the weight/weight ratio of the first organic solvent to water in the first evaporation feed is R13, wherein the weight/weight ratio of the first organic solvent to water in the azeotrope is R12 and wherein R13 is greater than R12 by at least 10%.

According to an embodiment, the method further comprises the steps of condensing the vapors in the first vapor phase to form two phases, a first organic solvent-rich one and a second water-rich one, separating the phases, using the first organic solvent-rich phase in step (iii), and using the second water-rich phase for generating the hydrolysis medium.

According to another embodiment, the method further comprises a step of treating the lignin composition to effect at least one of deacidification and solvent removal.

According to another embodiment, the treating comprises at least one of neutralizing a residual amount of HCl, centrifugation, displacement of residual solvent with water and drying.

According to another embodiment, hydrolyzing forms an HCl-comprising lignin stream, wherein forming the second lignin stream comprises separating HCl from the HCl-comprising lignin stream to form a third separated HCl stream and an HCl-depleted lignin stream and wherein the third separated HCl stream is used for generating the hydrolysis medium. According to a related embodiment, the amount, the purity and the concentration of HCl in the HCl-comprising lignin stream are W8, P8 and C8, respectively the amount, the purity and the concentration of HCl in the third separated HCl stream are W9, P9 and C9, respectively and wherein W9/W8 is greater than 0.1, P9/P8 is greater than 1.1, and C9/C8 is greater than 1.8,

According to a related embodiment, the method further comprises the steps of separating HCl from the HCl-depleted lignin stream to form a fourth separated HCl stream and using the fourth separated HCl stream for generating the hydrolysis medium. According to an embodiment, the amount of HCl in the fourth separated HCl stream is W10 and wherein W10/W8 is greater than 0.1.

Another aspect of some embodiments of the invention relates to a method for processing a lignocellulosic material and for the production of a carbohydrate composition comprising:

(i) providing a lignocellulosic material feed comprising a polysaccharide and lignin;

(ii) hydrolyzing the polysaccharide in an HCl-comprising hydrolysis medium to form a first aqueous solution comprising carbohydrates, HCl and water, wherein the weight/weight ratio of carbohydrates to water is in the range of between 0.4 and 3 and wherein the weight/weight ratio of HCl to water is in the range between 0.17 and 0.50; and a second lignin stream comprising lignin, HCl and water, wherein the weight/weight ratio of the lignin to water is in the range between 0.1 and 2.0 and wherein the weight/weight ratio of HCl to water is in the range between 0.15 and 1;

(iii) contacting the first aqueous solution with a second organic solvent to form a second evaporation feed, which second organic solvent forms with water a heterogeneous azeotrope and is characterized by at least one of:

(a2) having a polarity related component of Hoy's cohesion parameter between 0 and 15 MPa^{1/2}

(b2) having a hydrogen bonding related component of Hoy's cohesion parameter between 0 and 20 MPa^{1/2}; and

(c2) having a solubility in water of less than 15%, and forming a heterogeneous azeotrope with water wherein the weight/weight ratio of said second organic solvent to water is in the range of between 50 and 0.02, or in the range of between 50 and 0.02, and wherein the solubility of water in said organic solvent is less than 20%; and

(iv) evaporating water, HCl and the second organic solvent from said second evaporation feed at a temperature below 100° C. and at a pressure below 1 atm, whereupon a second vapor phase and a viscous fluid as defined hereinbefore, are formed.

Another aspect of some embodiments of the invention relates to a method for processing a lignocellulosic material and for the production of a carbohydrate composition comprising:

(v) providing a lignocellulosic material feed comprising a polysaccharide and lignin;

(vi) hydrolyzing the polysaccharide in an HCl-comprising hydrolysis medium to form a first aqueous solution comprising carbohydrates, HCl and water, wherein the weight/weight ratio of carbohydrates to water is in the range of between 0.4 and 3 and wherein the weight/weight ratio of HCl to water is in the range between 0.17 and 0.50; and a second lignin stream comprising lignin, HCl and water, wherein the weight/weight ratio of the lignin to water is in the range between 0.1 and 2.0 and wherein the weight/weight ratio of HCl to water is in the range between 0.15 and 1;

(vii) contacting the first aqueous solution with a second organic solvent to form a second evaporation feed, which second organic solvent forms with water a heterogeneous azeotrope and is characterized by at least one of:

(a2) having a polarity related component of Hoy's cohesion parameter between 0 and 15 MPa^{1/2}

(b2) having a hydrogen bonding related component of Hoy's cohesion parameter between 0 and 20 MPa^{1/2}; and

(c2) having a solubility in water of less than 15%, and forming a heterogeneous azeotrope with water wherein the weight/weight ratio of said second organic solvent to water is in the range of between 50 and 0.02, or in the range of between 50 and 0.02, and wherein the solubility of water in said organic solvent is less than 20%; and

(viii) evaporating water, HCl and the second organic solvent from said second evaporation feed at a temperature below 100° C. and at a pressure below 1 atm, whereupon a second vapor phase and a viscous fluid as defined hereinbefore are formed;

(ix) contacting the second lignin stream with a first organic solvent to form a first evaporation feed, which first organic solvent forms a heterogeneous azeotrope with water and is characterized by at least one of:

(a1) having a polarity related component of Hoy's cohesion parameter between 0 and 15 MPa^{1/2}.

(b1) having a Hydrogen bonding related component of Hoy's cohesion parameter between 0 and 20 MPa^{1/2}; and

(c1) having a solubility in water of less than 15%, and forming a heterogeneous azeotrope with water wherein the weight/weight ratio of the first organic solvent to water is in the range of between 5 and 0.2, and wherein the solubility of water in the organic solvent is less than 20% and

(x) evaporating water, HCl and the first organic solvent from the first evaporation feed at a temperature below 100° C. and at a pressure below 1 atm, whereupon a first vapor phase and a lignin composition as described hereinbefore are formed.

According to an embodiment, the hydrolysis medium is made with a recycled reagent HCl stream, wherein HCl purity and concentration are P6 and C6, respectively and wherein P6 is greater than 80% and C6 is greater than 30% (as calculated by 100 time HCl weight divided by the combined weights of HCl and water).

According to another embodiment, the weight/weight ratio of said second organic solvent to water in said second evaporation feed is R23, wherein the weight/weight ratio of said second organic solvent to water in said azeotrope is R22 and wherein R23 is greater than R22 by at least 10%.

According to another embodiment, the method further comprises the steps of condensing the vapors in said second vapor phase to form two phases, a second organic solvent-rich one and a first water-rich one, separating said phases, using said second organic solvent-rich phase in step (iii) and using said first water-rich phase for generating said hydrolysis medium.

According to an embodiment, the viscous fluid comprises oligomers, and the method further comprises at least one of HCl hydrolysis of the oligomers, enzymatic hydrolysis of the oligomers, fermentation of the carbohydrates and simultaneous saccharification and fermentation of the oligomers.

According to another embodiment, the method further comprises the step of spray drying the viscous fluid to form a de-acidified solid carbohydrate composition. According to a related embodiment, the weight/weight ratio of HCl to carbohydrates in the de-acidified solid carbohydrate composition is less than 0.03.

According to a related embodiment, the de-acidified solid carbohydrate composition comprises oligomers, and the method further comprises at least one of acid hydrolysis of the oligomers, enzymatic hydrolysis of the oligomers, fermentation of the carbohydrates and simultaneous saccharification and fermentation of the oligomers.

According to another embodiment, the method further comprises a step of treating the lignin composition to effect at least one of deacidification and solvent removal. According to a related embodiment, the treating comprises at least one of neutralizing a residual amount of HCl, displacement of residual solvent with water, centrifugation and drying.

According to another embodiment, the weight/weight ratio of the first organic solvent to water in the first evaporation feed is R13, wherein the weight/weight ratio of the first organic solvent to water in the azeotrope is R12 and wherein R13 is greater than R12 by at least 10%.

According to another embodiment, the method further comprises the steps of condensing the vapors in the first vapor phase to form two phases, a first organic solvent-rich one and a second water-rich one, separating the phases, using the first organic solvent-rich phase in step (v) and using the second water-rich phase for generating the hydrolysis medium.

According to an embodiment, said hydrolyzing forms a hydrolyzate, forming said first aqueous solution comprises separating a portion of the HCl from said hydrolyzate to form a first separated HCl stream and an HCl-depleted hydrolyzate and said first separated HCl stream is used for generating said hydrolysis medium.

According to still another embodiment the amount, the purity and the concentration of HCl within said hydrolyzate are W4, P4 and C4, respectively and the amount, the purity and the concentration of HCl in said first separated HCl stream are W5, P5 and C5, respectively, and W5/W4 is greater than 0.1, P5/P4 is greater than 1.8, and C5/C4 is greater than 1.8.

According to a related embodiment, the method further comprises the steps of separating another portion of HCl from said HCl-depleted hydrolyzate to form a second separated HCl stream, and using said second separated HCl stream for generating said hydrolysis medium.

According to a related embodiment, the amount, the purity and the concentration of HCl in said second separated HCl stream are W7, P7 and C7, respectively, and W7/W4 is greater than 0.1, P7/P4 is greater than 1.8, and C7/C4 is greater than 0.4.

According to another embodiment, the hydrolyzing forms an HCl-comprising lignin stream, wherein forming the second lignin stream comprises separating HCl from the HCl-comprising lignin stream to form a third separated HCl stream and an HCl-depleted lignin stream and wherein the third separated HCl stream is used for generating the hydrolysis medium. According to a related embodiment, the amount, the purity and the concentration of HCl in the HCl-comprising lignin stream are W8, P8 and C8, respectively, the amount, the purity and the concentration of HCl in the third separated HCl stream are W9, P9 and C9, respectively, and wherein W9/W8 is greater than 0.1, P9/P8 is greater than 1.1, and C9/C8 is greater than 1.8.

According to another embodiment, said viscous solution comprises carbohydrate oligomers and the method further comprises the steps of diluting said viscous fluid to form oligomers and an HCl-comprising diluted fluid and maintaining said diluted fluid at a temperature and for a residence time sufficient for the hydrolysis of at least 50% of said oligomers.

According to another embodiment, the method further comprises the steps of separating HCl from the HCl-depleted lignin stream to form a fourth separated HCl stream, and using the fourth separated HCl stream for generating the hydrolysis medium. According to a related embodiment, the amount of HCl in the fourth separated HCl stream is W10 and wherein W10/W8 is greater than 0.1.

In some exemplary embodiments of the invention, the first organic solvent and the second organic solvent are of essentially the same chemical composition. In some exemplary embodiments of the invention, the first organic solvent is of essentially the same composition as the second organic solvent. According to a related embodiment, the method for the production of carbohydrate comprises (i) providing a lignocellulosic material feed comprising a polysaccharide and lignin; (ii) hydrolyzing the polysaccharide in an HCl-comprising hydrolysis medium to form a first aqueous solution comprising carbohydrates, HCl and water, wherein carbohydrates to water weight/weight ratio is in the range between 0.4 and 3 and wherein HCl/water weight/weight ratio is in the range between 0.17 and 0.50; and a second lignin stream comprising lignin, HCl and water, wherein lignin to water weight/weight ratio is in the range between 0.1 and 2.0 and wherein HCl/water weight/weight ratio is in the range between 0.15 and 1; (iii) contacting the first aqueous solution with an organic solvent to form a second evaporation feed, which solvent forms with water a heterogeneous azeotrope and is characterized by at least one of (a) having a polarity related component of Hoy's cohesion parameter between 0 and 15 MPa^{1/2}, (b) having a hydrogen bonding related component of Hoy's cohesion parameter between 0 and 20 MPa^{1/2}, and (c) having solubility in water smaller than 15% wt, and forming a heterogeneous azeotrope with water wherein the weight/weight ratio of the second organic solvent to water ratio is in the range between 0.2 and 5, and wherein the solubility of water in the organic solvent is less than 20%, (iv) evaporating water, HCl and a second organic solvent from the second evaporation feed at a temperature below 100° C. and at a pressure below 1 atm, whereupon a second vapor phase and a viscous fluid as described above are formed; (v) contacting the second lignin stream with the organic solvent to form a first evaporation feed, (vi) evaporating water, HCl and the first organic solvent from the first evaporation feed at a temperature below 100° C. and at a pressure below 1 atm, whereupon a first vapor phase and a lignin composition as described above are formed.

The invention also provides, a hetero-oligosaccharides composition comprising tetramers composed of glucose and at least two sugars selected from the group consisting of mannose, xylose, galactose, arabinose and fructose.

According to various exemplary embodiments of the invention the method includes separating HCl from said HCl-comprising diluted fluid by means selected from the group consisting of solvent extraction, membrane separation, ion-exchange, spray drying and combinations thereof to form a de-acidified carbohydrates solution.

In some embodiments, the method further comprises combining at least portions of multiple HCl-comprising streams to reform a recycled HCl reagent stream.

According to a related embodiment, the combining is of at least two HCl-comprising streams selected from the group consisting of the first separated HCl stream, the second separated HCl stream, the third separated HCl stream, the fourth separated HCl stream, the first water rich phase and the second water-rich phase.

The amount, concentration and purity of HCl in the recycled reagent HCl stream are W6, C6 and P6, respectively. According to an embodiment, W6/W4 is greater than 1, optionally at least 1.2, at least 1.5 or at least 1.8. According to an embodiment, P6 is greater than 80%, optionally greater than 85%, greater than 90% or greater than 95%. According to another embodiment, C6 is greater than 30%, optionally greater than 35%, greater than 38% or greater than 40% (as calculated by 100 time HCl weight divided by the combined weights of HCl and water).

According to still another embodiment, the method further comprises the steps of diluting said viscous fluid to form the HCl-comprising diluted fluid, neutralizing at least a fraction of said HCl to form a diluted fluid comprising a chloride salt and carbohydrates, and separating said salt from said carbohydrates by means selected from membrane separation and chromatography to form a de-acidified carbohydrates solution.

According to an embodiment, the weight/weight ratio of HCl to carbohydrates within said de-acidified carbohydrate solution is less than 0.03.

Another aspect of some embodiments of the invention relates to a tetramers composition comprising hetero-oligosaccharides with a degree of polymerization of at least tetramers, which tetramers are composed of glucose and at least one sugar selected from the group consisting of mannose, xylose, galactose, arabinose and fructose, optionally at least two sugars from said list and optionally at least three sugars from said list. According to an embodiment, said composition comprises at least two types of hetero-tetramers, each one of which is composed of glucose and at least one sugar selected from the group consisting of mannose, xylose, galactose, arabinose and fructose, optionally at least two sugars from said list. In some exemplary embodiments of the invention, said tetramers composition is essentially HCl free. The term hetero-oligosaccharides, as used here, means oligosaccharides composed of at least two different sugars.

According to an embodiment, the sugars in said tetramers form at least 0.5% wt of the sugars in said tetramers composition, optionally at least 1% wt or at least 1.5% wt. According to a related embodiment, the rest of the sugars in said tetramers composition are in the forms of monomers, dimers, trimers and oligomers with a degree of oligomerization greater than four. According to a related embodiment, at least a fraction of said dimers, trimers and oligomers with a degree of oligomerization greater than four are hetero-oligosaccharides. According to an embodiment, the sugar concentration in said tetramer composition is greater than 20% wt, optionally greater than 25%, greater than 30% or greater than 35% wt. The term hetero-oligosaccharides, as used herein, means oligosaccharides composed of at least two different sugars.

In some exemplary embodiments of the invention, there is provided a method including: (i) contacting an initial volume of solution comprising carbohydrates, HCl and water with a second organic solvent to form a second evaporation feed wherein the second organic solvent forms a heterogeneous azeotrope with water has a polarity related component of Hoy's cohesion parameter between 0 and 15 MPa^{1/2} and/or has a hydrogen bonding related component of Hoy's cohesion parameter between 0 and 20 MPa^{1/2} and has a solubility in water of less than 20%; (ii) evaporating water, HCl and said second organic solvent from said second evaporation feed at a temperature below 100° C. and at a pressure below 1 atm, to produce a smaller volume of a viscous fluid according to claim 1; and (iii) spray drying the smaller volume. In some embodiments, the method includes preparing the initial volume of solution comprising carbohydrates, HCl and water by: hydrolyzing a polysaccharide-comprising feed in an HCl-comprising hydrolysis medium to produce a hydrolyzate; and separating ≧50% of the HCl and ≧50% of the water from the hydrolyzate to produce said initial volume of solution.

### BRIEF DESCRIPTION OF THE DRAWINGS

Various embodiments of the invention are now described in connection with certain exemplary embodiments with reference to the following illustrative FIGURE and examples so that it may be more fully understood.

FIG. 1 is a flow diagram of a process according to an exemplary embodiment of the invention.

With specific reference now to the FIGURE in detail, it is stressed that the particulars shown are by way of example and for purposes of illustrative discussion of the exemplary embodiments of the invention only and are presented in the cause of providing what is believed to be the most useful and readily understood description of the principles and concepts of one of the methods of the invention. In this regard, no attempt is made to show details of the invention in more detail than is necessary for a fundamental understanding of the invention, the description taken with the attached FIGURE making apparent to those skilled in the art how the several forms of the invention may be embodied in practice.

### DETAILED DESCRIPTION OF THE INVENTION

In some embodiments, the term “consisting essentially of” refers to a composition whose only active ingredients are the indicated active ingredients, however, other compounds may be included which are involved directly in the technical effect of the indicated active ingredients. In some embodiments, the term “consisting essentially of” refers to a composition whose only active ingredients acting in a particular pathway, are the indicated active ingredients, however, other compounds may be included which are involved in the indicated process, which for example have a mechanism of action related to but not directly to that of the indicated agents. In some embodiments, the term “consisting essentially of” refers to a composition whose only active ingredients are the indicated active ingredients, however, other compounds may be included which are for stabilizing, preserving, etc. the composition, but are not involved directly in the technical effect of the indicated active ingredients. In some embodiments, the term “consisting essentially of” may refer to components which facilitate the release of the active ingredients. In some embodiments, the term “consisting essentially of” refers to a composition, which contains the active ingredients and other acceptable solvents, which do not in any way impact the technical effect of the indicated active ingredients.

In some exemplary embodiments of the invention, there is provided a viscous fluid consisting essentially of: between 2% wt and 25% wt water, at least 75% wt carbohydrate, as calculated by 100 times carbohydrate weight divided by the combined weights of the carbohydrate and water, between 0% wt and 25% wt of a second organic solvent and between 10% wt and 55% wt HCl, as calculated by 100 time HCl weight divided by the combined weights of HCl and water, which second organic solvent is characterized by at least one of: (a2) having a polarity related component of Hoy's cohesion parameter between 0 and 15 MPa^{1/2}; (b2) having a Hydrogen bonding related component of Hoy's cohesion parameter between 0 and 20 MPa^{1/2}; and (c2) having a solubility in water of less than 15% and forming a heterogeneous azeotrope with water, wherein the weight/weight ratio of said second organic solvent to water is in the range of between 50 and 0.02, and wherein the solubility of water in said organic solvent is less than 20%.

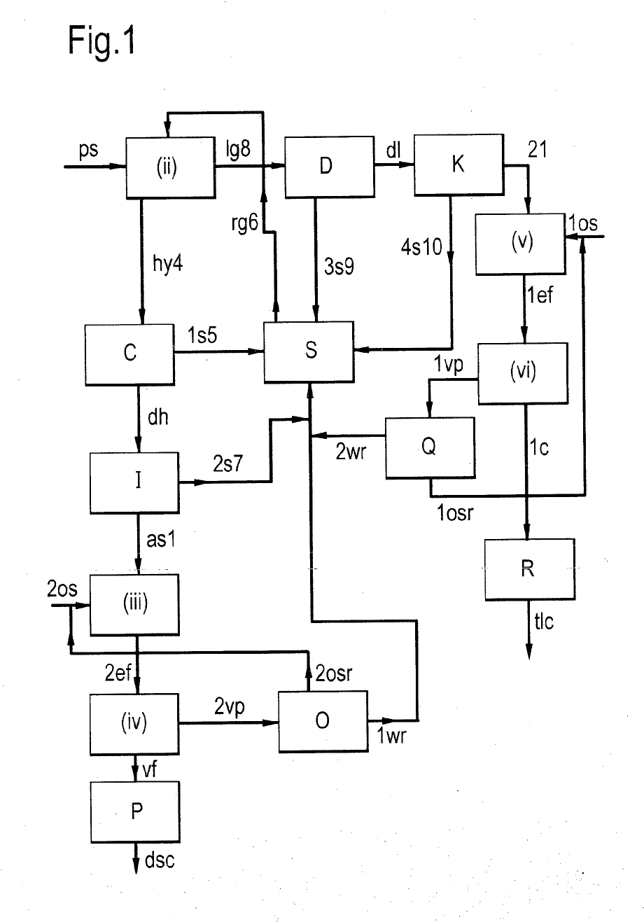

Exemplary embodiments of the invention are described in the following in reference to the flow diagram in FIG. 1. In the following, numbers and letters in [X] refer to operations (boxes in the diagram) and numbers and letters in <X> refer to streams (arrows).

According to an exemplary embodiment of a method, a polysaccharide in a polysaccharide-comprising feed (<ps> in FIG. 1) is hydrolyzed in an HCl-comprising hydrolysis medium (hydrolysis takes place in [(ii)]). Unless specified otherwise, the term acid hereinafter means HCl. According to a some embodiments, the polysaccharide-comprising feed is a lignocellulosic material, also referred to herein as a lignocellulosic material feed or lignocellulosic feed. According to an embodiment, HCl concentration in the hydrolysis medium is greater than 30%. The hydrolysis medium is formed, according to an embodiment, by contacting the lignocellulosic feed with a recycled reagent HCl stream <rg6>. According to an embodiment of the invention, within the recycled reagent HCl, the concentration and purity of HCl are C6 and P6, respectively. According to an embodiment, P6 is greater than 80%, greater than 85%, greater than 90% or greater than 95%. According to another embodiment, C6 is greater than 30%, greater than 35%, greater than 38% or greater than 40%, as calculated by 100 time HCl weight divided by the combined weights of HCl and water.

According to one embodiment, said contacting is carried out in a batch mode, while according to another it is carried out in a continuous mode. According to an exemplary embodiment, contacting is conducted in a counter-current mode, e.g. in a tower reactor into which, according to one embodiment, the lignocellulosic feed is introduced from top and the recycled reagent HCl stream flows in from the bottom. The recycled reagent HCl stream comes in containing essentially no carbohydrates. As the reagent stream flows upwards, carbohydrates from polysaccharides hydrolysis start to build up in it. At the same time, the lignocellulosic material losses its polysaccharides as it moves downwards, counter-currently to the recycled reagent HCl stream.

According to an exemplary embodiment, the lignocellulosic material is fed into a series of N reactors—numbered for the purpose of the explanation here—as D₁ to D_{N} (wherein reactors D₁ to D_{N} are not shown in FIG. 1). The recycled reagent HCl stream is introduced into D_{N} for a contact of a selected residence time. Then, it is separated and moved to reactor D_{N-1} for an additional contact of a selected residence time, after which it is moved to D_{N-2}, etc. Finally, it is moved into reactor D₁ for a contact of a selected time with a fresh lignocellulosic solid material. Thus, the fresh solid material is contacted first with an aqueous HCl solution that was previously contacted N−1 times. At the end of the selected residence time, the aqueous HCl solution is removed from the reactor and the solid material is contacted again with an aqueous HCl solution, this time with one that was previously contacted N−2 times. Finally, the solid material is contacted with a fresh recycled reagent HCl stream at the end of which the residual solid is separated and removed from the reactor. The emptied reactor is then re-filled with fresh lignocellulosic material and goes again through the series of contacts, i.e. starting with contact with an aqueous HCl solution that was previously contacted N−1 times. According to an exemplary embodiment, while the aqueous HCl solution moves from one reactor to the other, the solid material stays in the same reactor for N contacts, after which it is removed.

Various polysaccharide-comprising feeds are suitable according to the method of the invention. The terms saccharide, sugar and carbohydrate in both singular and plural forms are used herein interchangeably. Any polysaccharide is suitable, e.g. polymers of the monomers glucose, xylose, arabinose, mannose, galactose, and their combination. The monomers of interest are typically of either 6 carbon sugars (hexoses) or 5 carbon sugars (pentoses). The terms glucose and dextrose are used here interchangeably. The polymers could be homogenous, i.e. composed of only one type carbohydrate, and or heterogeneous, i.e. comprised of different carbohydrates, e.g. arabinoxylene consisting mainly of xylose and arabinose or glucomannane consisting mainly of glucose and mannose. Various polysaccharides are suitable for the method of the invention. Of particular interest are cellulose and hemicellulose.

Any polysaccharide-comprising feed is suitable, particularly ones that comprise cellulose, e.g. recycled paper, co-products of the pulp and paper industry, biomass cell walls and the like. Of particular interest are lignocellulosic materials. As used here, the term lignocellulosic material, or lignocellulosic material feed, refers to any material comprising cellulose and lignin. Typically, lignocellulosic material further comprises hemicellulose, additional components such as extractives and mineral compounds. The weight ratios between the various components—mainly the three major ones, i.e. cellulose, hemicellulose and lignin—change according to the source of the lignocellulosic material. The same is true for the content of mineral compounds, also referred to as ashes and for the extractives.

The term extractives, as used herein, means oil-soluble compounds present in various lignocellulosic feeds, e.g. tall oils. Various lignocellulosic materials are known and are suitable for the invention. Of particular interest are wood, wood-processing co-products such as wood chips from oriented strand boards production, agricultural residues such as stover and corn cobs, sugar cane bagasse, switch grass and other energy crops, and various combinations of those. Lignocellulosic material could be used as such or after some pre-treatment. Any pre-treatment that does not lead to the hydrolysis of the majority of the cellulose content is suitable.

According to an embodiment, the lignocellulosic material is dried prior to the combining with the recycled reagent HCl stream. Lignocellulosic material could be obtained from various sources at various degrees of moisture. Various methods of drying are suitable. According to an embodiment, drying is to a moisture content of about 10% or lower.

According to another embodiment, the lignocellulosic material is comminuted prior to the combining with the recycled reagent HCl stream.

According to an embodiment, the lignocellulosic material is pre-treated for the removal and/or for the hydrolysis of hemicellulose prior to the combining with the recycled reagent HCl stream. Such removal and/or hydrolysis could be conducted by various means, e.g. elevated temperature treatment with water/steam and/or with dilute HCl solution, enzymatic hydrolysis, and the like. Such treatment extracts hemicellulose into an aqueous phase, hydrolyzes hemicellulose into water soluble sugars and combinations of those, leading to lignocellulosic material wherein cellulose is the main polysaccharide. According to an exemplary embodiment, the polysaccharides of the lignocellulosic material are not hydrolyzed, nor extracted prior to the combining with the recycled reagent HCl stream.

According to other embodiments, the lignocellulosic material is pre-treated by at least one of steam explosion, ammonia explosion and delignification.

According to the embodiment wherein the lignocellulosic material undergoes pre-hydrolysis or hemicellulose extraction, the hydrolysis in [(ii)] of FIG. 1 is mainly of cellulose. According to the embodiment wherein there is no pre-hydrolysis or extraction of hemicellulose, both hemicellulose and cellulose are hydrolyzed in [(ii)]. HCl acts as a catalyst and is not consumed, except possibly for neutralizing basic components of the lignocellulosic material.

According to an embodiment of the invention, at least 70% wt of the polysaccharides in the feed material hydrolyze into soluble carbohydrates, optionally more than 80%, more than 90% or more than 95%. According to an embodiment, hydrolysis forms soluble carbohydrates. Accordingly, the concentration of the soluble carbohydrates in the medium increases with the progress of the hydrolysis reaction.

As indicated, according to an embodiment, the fresh lignocellulosic material is contacted several times with an HCl solution, which leads to an increased degree of hydrolysis of its polysaccharides content. According to an embodiment, when removed from D_{N}, essentially all the polysaccharides content of a lignocellulosic material feed is hydrolyzed into soluble carbohydrates, while the lignin content stays essentially insoluble. According to an embodiment, the removed insoluble lignin is in the form of a solid dispersion in an HCl solution or as a wet cake wetted by such solution. That removed composition forms, according to an embodiment, an HCl-comprising lignin stream of the invention (<lg8> in FIG. 1). According to an embodiment of the invention, in said HCl-comprising lignin stream, HCl amount, concentration and purity are W8, C8 and P8, respectively.

As the recycled HCl stream moves through the reactors, its carbohydrates content increases and reaches the maximal value at the end of the contact with the fresh lignocellulosic material. According to an embodiment, after contact with the fresh lignocellulosic material, the aqueous solution is removed from D₁ (not shown) which is a component of (ii) in FIG. 1, and used to form the first aqueous solution comprising carbohydrates, HCl and water. The removed aqueous solution is also referred to as the hydrolyzate (<hy4> in FIG. 1).

According to the method of the invention, in that first aqueous solution, the carbohydrates to water weight/weight ratio is in the range of 0.4 to 2.0 or 0.7 to 2.8 or 1.0 to 2.5 or 1.5 to 2.2 or 0.2 to 2.0 or 0.3 to 1.5 or 0.4 to 1.0 or 0.5 to 0.9 and the HCl/water weight/weight ratio is in the range of 0.17 to 0.6, or 0.20 to 0.50 or 0.25 to 0.40. According to an embodiment, this first aqueous solution is a product of further treating the formed hydrolyzate, as further described in the following.

According to an embodiment of the invention, in the hydrolysis-formed hydrolyzate, HCl amount, concentration and purity are W4, C4 and P4, respectively. In some embodiments, said hydrolyzate is essentially solids free, meaning containing essentially no insoluble compounds. According to an embodiment, said hydrolyzate comprises solids and those are separated by at least one of filtration and centrifugation. According to another embodiment, the carbohydrate concentration in <hy4> is greater than 15% wt (as calculated by 100CH/(CH+W), wherein CH and W are the weights of the carbohydrates and the water, respectively), optionally greater than 20% wt, greater than 25% wt or greater than 30% wt. While there is no significant consumption of HCl in the hydrolysis process, W4 is in many cases smaller than the amount of HCl in the recycled HCl reagent (W6), since part of the acid is contained in <lg8>. C4 is similar in size to HCl concentration in that reagent (C6), but typically somewhat smaller. As carbohydrates are being added into the solution during the hydrolysis, the purity of HCl in the solution decreases. According to various embodiments, P4 is between 20% and 70% or between 30% and 60%.

In some exemplary embodiments of the invention, the hydrolysis and the contacting of the present method are conducted in a continuous mode. In that case, amounts of stream and of components are presented in terms of flow rate, e.g. as the ratio between the flow rate of HCl and that of the initial lignocellulosic material feed in the hydrolysis medium. According to some embodiments, that weight/weight ratio is between 0.2 and 5 or between 0.5 and 3.

Unless specified otherwise, the concentration of a component in a medium, e.g. in a gaseous stream, a solution or a suspension, is presented in weight percent (% wt) calculated from the weight, or flow rate, of said component in that medium and the combined weights, flow rates, of that component and the water in that medium. Thus, e.g. in a medium composed of 30 Kg water, 20 Kg of HCl and 50 Kg of carbohydrate, the concentration of HCl according to the presentation here is 40%. In some other cases, as indicated, the concentration is on an “as is” basis, i.e. calculated from the weight, flow rate, of the component in that medium divided by the total weight, flow rate, of the medium.

Unless specified otherwise, the purity of a component in a medium is the purity in a homogeneous phase (liquid and/or gas). In case the medium comprises insolubles, the purity referred to is that in the solution that would form on separation of those insolubles. Unless specified otherwise, the purity is calculated on a water-free, or solvent-free, and weight basis. Thus, HCl purity in a solution composed of 50 Kg water, 20 Kg of HCl and 20 Kg of carbohydrate and 10 Kg mineral salt, as presented here, is 40%.

According to an embodiment, the lignocellulosic feed further comprises an organic compound, e.g. tall oil, and a fraction of the organic compound is dissolved and/or dispersed in the formed hydrolyzate. According to a related embodiment, the organic compound-comprising hydrolyzate is brought into contact at a temperature T3 with a third organic solvent (not shown in FIG. 1), whereupon said organic compound selectively transfers to said third organic solvent to form an organic compound-depleted hydrolyzate and a first organic compound-carrying solvent.

According to an embodiment, the first organic compound-carrying solvent has a commercial value as such. According to another embodiment, the method further comprises a step of recovering said third organic solvent and organic compound from said first organic compound-carrying solvent to form a separated organic compound and a regenerated third organic solvent. Various methods are suitable for such recovering, including distilling the third organic solvent and extracting it into another solvent, wherein the organic compound has limited miscibility. According to an embodiment, said organic compound is a tall oil. According to an embodiment, the separated organic compounds formed according to the invention differ in composition from present commercial products and are of higher quality. Without wishing to be limited by theory, that could be the results of recovery in an acidic medium and/or of fractionation between the various streams of the process. Thus, the organic compounds extracted from the hydrolyzate can be enriched in components, which at high HCl concentration, typically greater than 30%, dissolve in the aqueous medium, rather than adsorb on the solid lignin product of hydrolysis.

In some exemplary embodiments of the invention, said contacting of the hydrolyzate with the third organic solvent is conducted while the hydrolyzate is high in HCl concentration, e.g. while the HCl concentration therein is at least 25%, at least 28% or at least 32%. According to a related embodiment, said contacting is conducted prior to the following step of separating a portion of the HCl in the hydrolyzate. The inventors have found that the solubility of some of those organic compounds in the hydrolyzate decreases with decreasing HCl concentration. Contacting with the third organic solvent while HCl concentration is still high provides for high yield of recovering organic compounds on one hand and avoids their precipitation in the next steps, which precipitation may form undesired coating of equipment.

The method of the presented invention further comprises a step [C] of separating a portion of the HCl from said hydrolyzate to form a first separated HCl stream <1s5> wherein HCl amount, concentration and purity are W5, C5 and P5, respectively, and an HCl-depleted hydrolyzate <dh>. In some exemplary embodiments of the invention, said separation involves distilling HCl out of the hydrolyzate and the first separated HCl stream <1s5> is gaseous. Optionally, a significant fraction of the HCl in the hydrolyzate is distilled out in [C], so that W5/W4 is greater than 0.1, greater than 0.2, greater than 0.25 or greater than 0.3. The first separated HCl stream may contain small amounts of water, e.g. water vapors in a gaseous first separated HCl stream, and possibly also small amounts of some other volatile components of the hydrolyzate. Yet, both C5 and P5 are high, typically greater than 90%, greater than 95% and or greater than 97%. According to an embodiment, P5/P4 is greater than 1.8, greater than 2.0, greater than 2.2 or greater than 2.5. According to another embodiment, C5/C4 is greater than 1.8, greater than 2.0, greater than 2.2 or greater than 2.5.

According to an embodiment, the method further comprises a step [I] of separating another portion of HCl from the HCl-depleted hydrolyzate to form a second separated HCl stream <2s7> wherein HCl amount, concentration and purity are W7, C7 and P7, respectively, and a further-depleted hydrolyzate, which according to some embodiments, forms a first aqueous solution within the invention (<as1> in FIG. 1). In some exemplary embodiments of the invention, said separation in [I] involves distilling HCl out of the HCl-depleted hydrolyzate and the second separated HCl stream is gaseous. Optionally, a significant fraction of the HCl in the HCl-depleted hydrolyzate is distilled out in [I], so that W7/W4 is greater than 0.1, greater than 0.2, greater than 0.3 or greater than 0.4. Said second separated HCl stream is, according to some embodiments a water-HCl azeotrope so that C7 is about azeotropic. The second separated HCl stream <2s7> can be essentially carbohydrate free, but may contain small amounts of volatile components of the hydrolyzate. Yet, P7 is high, typically greater than 90%, greater than 95% or greater than 97%. According to an embodiment, P7/P4 is greater than 1.8, greater than 2.0, greater than 2.2 or greater than 2.5. According to another embodiment, C7/C4 is greater than 0.4, greater than 0.5, greater than 0.6 or greater than 0.7.

As indicated, according to an embodiment, said separating in [I] involves distilling HCl and the second separated HCl stream is of azeotropic concentration. It is important to note that, according to an exemplary embodiment, distilling here and optionally other distillation steps in the method of the invention are conducted at sub-atmospheric pressure in order to maintain low distillation temperature so that undesired degradation of carbohydrates is avoided. The composition of the azeotrope changes with the distillation temperature. As used herein, the term azeotropic composition refers to the composition of the azeotrope at the conditions—including temperature and pressure—of the distillation. In addition, the azeotropic composition is also affected by the presence of other solutes in the solution. Thus, the azeotropic composition of the second separated HCl stream may vary with the concentration of carbohydrates in the distilled solution.

Since the azeotropic distillation in [I] separates both HCl and water, the carbohydrates concentration increases during the distillation. According to an embodiment of the invention, the carbohydrates concentration in <dh> is in the range between 20% and 40% and that concentration in <as1> is greater than that in <dh> by at least 50%. According to an embodiment, the carbohydrates concentration in <as1> is greater than 30% wt, greater than 40% wt, greater than 50% wt or greater than 55% wt.

In the hydrolyzate <hy4>, HCl/carbohydrates weight/weight ratio is typically about 1 or greater than 1. According to various embodiments, the distillations in [C] and [I] remove together about 50%-70% of that initial HCl content and about a similar proportion of the initial water content there. In order to approach a full recovery of the acid, the rest of the acid in that stream should be removed. Spray drying is economically unattractive. On a large industrial scale, e.g. about 100 tons of carbohydrates per hour or more, the amounts of water and acid to be distilled would make spray drying of <as1> highly expensive in both capital and operating cost. The inventors of the invention have found a way to further remove acid and water from <as1>.

According to an embodiment of the invention, the hydrolyzate, the depleted hydrolyzate, the further depleted hydrolyzate and or the first aqueous stream (<as1> in FIG. 1) is contacted ([(iii)] in FIG. 1) with a second organic solvent <2os> to form a second evaporation feed <2ef>. According to the method, water, HCl and the second organic solvent are distilled ([(iv)] in FIG. 1) from said second evaporation feed, optionally at a temperature below 100° C. and at a pressure below 1 atm, whereupon a second vapor phase (<2vp> in FIG. 1) and a viscous fluid (<vf> in FIG. 1) are formed. According to an embodiment, at least one of the temperature and the pressure vary during the distillation operation, but during at least a fraction of the distillation time, temperature is below 100° C. and pressure is below 1 atm.

According to an embodiment, in the hydrolyzate, the depleted hydrolyzate, the further depleted hydrolyzate and or the first aqueous stream, when contacting with the second solvent the carbohydrates to water weight/weight ratio is in the range between 0.4 and 3.0, between 0.7 and 2.8, between 1.0 and 2.5 or between 1.5 and 2.2, and the HCl/water weight/weight ratio is in the range between 0.17 and 0.5, between 0.20 and 0.40 or between 0.25 and 0.35.

The terms “organic solvent” and “solvent” are used herein interchangeably.

The first organic solvent and the second organic solvent of the invention are characterized by forming with water a heterogeneous binary azeotrope to be distinguished from a homogeneous binary azeotrope. In case two compounds (A and B) form a binary homogeneous azeotrope, at the azeotropic composition there is a single liquid phase with a given A/B ratio and when vapors are distilled out of it, they contain A and B at the same A/B ratio. Therefore, distillation does not change the composition of the liquid phase. The case of a heterogeneous azeotrope is different. In some exemplary embodiments of the invention, the second organic solvent and water are of limited mutual solubility. Combining them in ratios exceeding the solubility limits forms a binary system with two liquid phases—a solvent-saturated aqueous solution and a water-saturated solvent solution. Vapors distilled from that two-liquid phases binary system have—at determined temperature and pressure—a given solvent/water ratio. While these conditions are maintained and as long as the two phases are present in the liquid system, the solvent/water ratio in the vapor phase stays unchanged. The solvent/water ratio in the vapor phase is such that, on condensing the vapors, two phases are formed, i.e. the solvent/water ratio in the vapor phase is outside the mutual solubility limit.

According to an embodiment of the invention, the solubility of the second organic solvent in water, as determined, for example, by combining, at 25° C., an essentially pure solvent and de-ionized water, is less than 15% wt, less than 10% wt, less than 5% or less than 1%. According to another embodiment, the solubility of water in the second organic solvent, when similarly determined, is less than 20% wt, less than 15% wt, less than 10% or less than 8%. According to another embodiment, in the heterogeneous azeotrope with water, the second organic solvent to water weight/weight ratio is in the range between 50 and 0.02, between 20 and 0.05, between 10 and 0.1 or between 5 and 0.2.

Solubility data is presented herein as the concentration of the solute in a saturated solvent solution at 25° C. Thus, e.g. solvent solubility in water of 10% wt means that the concentration of the solvent in its saturated aqueous solution at 25° C. is 10% wt.

According to another embodiment, the second organic solvent is characterized by having a polarity related component of Hoy's cohesion parameter of between 0 and 15 MPa^{1/2}, between 4 MPa^{1/2} and 12 MPa^{1/2} or between 6 MPa^{1/2} and 10 MPa^{1/2}. According to still another embodiment, the second organic solvent is characterized by having a hydrogen bonding related component of Hoy's cohesion parameter of between 0 and 20 MPa^{1/2}, between 1 MPa^{1/2} and 15 MPa^{1/2} or between 2 MPa^{1/2} and 14 MPa^{1/2}.

The cohesion parameter or solubility parameter, was defined by Hildebrand as the square root of the cohesive energy density:

$$δ = \sqrt{\frac{Δ {E}_{vap}}{V}}$$

wherein ΔEᵥₐₚ and V are the energy or heat of vaporization and the molar volume of the liquid, respectively. Hansen extended the original Hildebrand parameter to a three-dimensional cohesion parameter. According to this concept, the total solubility parameter δ is separated into three different components, or, partial solubility parameters relating to the specific intermolecular interactions:

δ²=δ_{d}²+δₚ²+δₕ²

wherein δ_{d}, δₚ and δₕ are the dispersion, polarity, and Hydrogen bonding components respectively. Hoy proposed a system to estimate total and partial solubility parameters. The unit used for those parameters is MPa^{1/2}. A detailed explanation of that parameter and its components could be found in “CRC Handbook of Solubility Parameters and Other Cohesion Parameters”, second edition, pages 122-138. That and other references provide tables with the parameters for many compounds. In addition, methods for calculating those parameters are provided.

According to still another embodiment, the second organic solvent has a boiling point at 1 atm in the range between 100° C. and 200° C., between 110° C. and 190° C., between 120° C. and 180° C. or between 130° C. and 160° C.

In some exemplary embodiments of the invention, the second organic solvent is selected from the group consisting of C₅-C₈ alcohols, their chlorides and/or combinations thereof, including primary, secondary, tertiary and quaternary ones, including aliphatic and aromatic ones and including linear and branched ones, toluene, xylenes, ethyl benzene, propyl benzene, isopropyl benzene nonane and the like. As used herein, the terms evaporation and distillation and the terms evaporate and distill are interchangeable.

The viscous fluid formed in [(iv)] comprises at least one carbohydrate, water, HCl and optionally also the second solvent. The viscous fluid is homogeneous according to one embodiment and heterogeneous according to another. According to an embodiment, the viscous fluid is heterogeneous and comprises a continuous phase and a dispersed phase, in which the amount of carbohydrates and W is the amount of water. Typically, the majority of the carbohydrates in the viscous fluid are the products of hydrolyzing the polysaccharides of the polysaccharide comprising feed to hydrolysis (<ps>), typically a lignocellulosic material. Alternatively, carbohydrates from other sources are combined with those products of hydrolysis to form the second evaporation feed and end up in the viscous fluid. According to another embodiment, the viscous fluid comprises carbohydrates formed in isomerization of other carbohydrate, e.g. fructose formed from glucose.

According to various embodiments, the carbohydrates in the viscous solution are monomers, dimmers, trimers, higher oligomers, and their combinations. Those monomers, dimmers, trimers, and/or higher oligomers comprise monomers selected from the group consisting of glucose, xylose, mannose, arabinose, galactose, other sugar hexoses, other pentoses and combinations of those. In some exemplary embodiments of the invention, glucose is the main carbohydrate therein. The term monomers is used here to describe both non-polymerized carbohydrates and the units out of which oligomers are formed.

The water content of the viscous fluid is between 2% wt and 25% wt, between 3% wt and 20% wt, between 4% wt and 18% wt or between 5% wt and 15% wt (calculated “as is”). The HCl concentration of the viscous fluid is between 10% wt and 55% wt, between 15% wt and 50% wt, between 18% wt and 40% wt or between 20% wt and 38% wt as calculated by 100HCl/(HCl+W), wherein HCl is the amount of HCl in the viscous fluid and W is the amount of water therein. The second organic solvent content of the viscous fluid is between 0% wt and 25% wt, between 1% wt and 20% wt, between 2% wt and 18% wt or between 3% wt and 15% wt. According to an embodiment, the HCl/water weight/weight ratio in the viscous fluid is in the range between 0.20 and 1.0, between 0.3 and 0.9 or between 0.4 and 0.8. According to another embodiment, the carbohydrate/water weight/weight ratio in the viscous fluid is in the range between 2 and 20, between 3 and 15, between 4 and 12 or between 5 and 11. According to still another embodiment, the HCl/carbohydrate weight/weight ratio in the viscous fluid is in the range between 0.02 and 0.15, between 0.03 and 0.12, or between 0.04 and 0.10. According to an alternative embodiment the hydrolyzate, the HCl-depleted hydrolyzate, the further depleted hydrolyzate and or the first aqueous stream forms the second evaporation feed as such, i.e. with no addition of the second solvent. Water and HCl are distilled from the second evaporation feed at a temperature below 100° C. and at a pressure below 1 atm, whereupon the second vapor phase and the viscous fluid are formed. The viscous fluid of this alternative embodiment comprises carbohydrates, HCl and water according to the above composition, but no solvent. According to a first modification, evaporation starts in the absence of a solvent, and the second organic solvent is added to the composition during evaporation. According to a second modification, evaporation is conducted in the absence of a solvent, and the second organic solvent is added to the formed solution (distillation product) at the end of the evaporation. In both modifications, the viscous fluid comprises the second organic solvent according to the above composition.

The distillation in [(iv)] removes much of the acid and the water left in <as1> after HCl separation in [C] and [I]. According to an embodiment, the combined acid removal in [C], [I] and [(iv)] is greater than 80% of the initial acid content of the hydrolyzate, greater than 85%, greater than 90% or greater than 95%. According to another embodiment, the combined water removal in [C], [I] and [(iv)] is greater than 80% of the initial water content of the hydrolyzate, greater than 85%, greater than 90% or greater than 95%.

As a result of that water removal, the formed viscous fluid <vf> is highly concentrated in carbohydrates. It was surprisingly found that, according to an embodiment, the viscosity of the viscous fluid, as measure at 80° C. by the Brookfield method is less than 150 cP, less than 120 cP less than 100 cP or less than 90 cP. It is not clear how such relatively high fluidity was maintained in the highly concentrated <vf>. Without wishing to be limited by theory, a possible explanation to that could be some specific role the solvent plays in <vf> and/or the specific composition of the carbohydrate, e.g. the mix of carbohydrates it is made of and the degree and nature of oligomerization.

In some exemplary embodiments of the invention, the ratio between the amount of first aqueous solution and the amount of the second organic solvent contacted with it in [(iii)] is such that solvent is found in the viscous solution at the end of the distillation. In some exemplary embodiments of the invention, the solvent/water ratio in the viscous fluid is greater than the solvent/water ratio in the water-solvent heterogeneous azeotrope. According to an embodiment of the invention, in the viscous fluid the second organic solvent/water weight/weight ratio is R2, the second organic solvent has heterogeneous azeotrope with water and the second organic solvent/water weight/weight ratio in said azeotrope is R22, and R2 is greater than R22 by at least 10%, by at least 25%, by at least 40%, or by at least 50%. According to still another embodiment, the second organic solvent/water weight/weight ratio in said second evaporation feed is R23, the second organic solvent/water weight/weight ratio in said azeotrope is R22, and R23 is greater than R22 by at least 10%, by at least 25%, by at least 40% or by at least 50%.

According to an embodiment, the second organic solvent used to form the second evaporation feed is not pure, e.g. contains water and/or HCl. According to a related embodiment, the used second organic solvent is recycled from another step in the process, e.g. from condensate of a distillation step. In such case, R23 refers to the ratio between the amounts of solvent on a solutes-free basis and water. As indicated earlier, R22 may depend on the temperature of distillation, on its pressure and on the content of the other components in the evaporation feed, including HCl and carbohydrates. As used hereinbefore, R22 is referred to the second solvent/water weight/weight ratio in the solvent-water binary system. On distillation from the second evaporation feed, there is at least one additional volatile component, co-distilling with water and the solvent, i.e. HCl. Thus, this system could be referred to as a ternary system. In such a system the solvent/water ratio in the vapor phase may differ from that in the binary system. As indicated, that ratio may further depend on the carbohydrates concentration in the second evaporation feed. In such complex systems, R22 refers to the solvent/water ratio in the vapor phase formed on distilling from the second evaporation feed.

According to an embodiment, the method further comprises the steps of condensing the vapors in the second vapor phase (step [O] in FIG. 1) to form two phases, a second organic solvent-rich phase (<2osr> in FIG. 1) and a first water-rich phase (<1wr> in FIG. 1), using the second organic-rich phase in said contacting step [(iii)] and using the first water-rich phase for generating the hydrolysis medium. Any method of condensing is suitable, such as cooling, pressure increase or both. Typically, the second organic solvent-rich phase also comprises water and HCl and the first water-rich phase also comprises solvent and HCl. Any method of separating the phases is suitable, e.g. decantation and the like. The second organic solvent-rich phase is used in step [(iii)] as is or after some treatment, e.g. removal of dissolved water, HCl or both. The first water-rich phase is used for regenerating the hydrolysis medium as is or after some treatment.

As indicated, the combined HCl removal in [C], [I] and [(iv)] is high, possibly exceeding 95%. Yet, some acid remains and is optionally removed for high recovery as well as for the production of a low-acid product. Optionally, removal of residual acid contributes to a reduction in re-polymerization.

Thus, according to a some embodiments, the viscous fluid is further treated. Such further treatment ([P] in FIG. 1) comprises removal of residual HCl to form a de-acidified carbohydrate.

According to various embodiments, removal of residual HCl involves at least one of solvent extraction, membrane separation, ion-exchange, evaporation and spray drying. According to an embodiment, the viscous solution is diluted prior to such removal of HCl, while according to others it is not. According to an embodiment, the residual HCl is removed by solvent extraction, using for that purpose the extractants as described in PCT/IL2008/000278, PCT/IL2009/000392 and Israel Patent Application No: 201,330, the relevant teachings of which are incorporated herein by reference. According to another embodiment, the second organic solvent is used as the extractant for the removal of the residual HCl.

Some exemplary embodiments of the invention include neutralization of the residual acid to form a chloride salt and removing the salt to form the de-acidified carbohydrates solution and various combinations thereof.

In some exemplary embodiments of the invention, the method comprises removal of the residual HCl by distillation. According to a related embodiment, distillation is conducted on the viscous fluid as such or after slight modifications, such as minor adjustment of the carbohydrate concentration and changing the amount of the second organic solvent therein. Such changes in the amount may comprise adding or removing such solvent. Optionally, another solvent is added. In some exemplary embodiments of the invention, the ratio between the second organic solvent in the viscous fluid and the water there is such that on azeotropic distillation of water and the solvent, essentially all the water is removed, while excess solvent remains. Such excess solvent is removed, according to an embodiment, by further distillation or in a separate operation.

In some exemplary embodiments of the invention, the method comprises the step of spray drying ([P]) the viscous fluid to form the de-acidified solid carbohydrate composition (<dsc> in FIG. 1) and vapors of HCl, water and optionally the solvent. Spray drying conditions are adjusted, according to an embodiment, for removing essentially all the water from the viscous solution, while some of the second organic solvent may stay and be removed subsequently. According to an embodiment, the viscous fluid is sprayed, as such or after some modification into a hot vapor stream and vaporized. Solids form as moisture quickly leaves the droplets. A nozzle is usually used to make the droplets as small as possible, maximizing heat transfer and the rate of water vaporization. Droplet sizes range, according to an embodiment, from 20 to 180 μm depending on the nozzle. A dried powder is formed in a single step, within a short residence time and at a relatively low temperature, all of which minimize carbohydrates degradation. In some exemplary embodiments of the invention, the hot and dried powder is contacted with water in order to accelerate cooling and to form an aqueous solution of the carbohydrate. According to an embodiment, residual second solvent is distilled out of that carbohydrates solution.

Exemplary methods described here enable the removal of the majority of the acid at relatively low cost by combining distillation of HCl in [C] (as a nearly dry gas), in [I] (as a water-HCl azeotrope) and in [(iv)] (optionally as a mixture of HCl, water and second solvent vapors) and the efficient removal of the residual acid in spray drying. It was surprisingly found that residual HCl removal in spray drying is more efficient than suggested by the prior art. Thus, in some exemplary embodiments of the invention, in the de-acidified solid carbohydrate composition, HCl/carbohydrates weight/weight ratio is less than 0.03, less than 0.02, more less than 0.01 or less than 0.005. It is not clear how was such high efficiency of HCl removal in spray drying achieved. Without wishing to be limited by theory, possible explanation to that could be some specific role the solvent plays and/or the specific composition of the carbohydrate, e.g. the mix of carbohydrates it is made of and the degree and nature of oligomerization.

According to one embodiment reaching these low HCl concentrations in the de-acidified carbohydrates solution typically represents high yield of acid recovery from the hydrolyzate of the lignocellulosic material. Thus, according to an embodiment of the method, at least 95% of the acid in the hydrolyzate is recovered, optionally at least 96%, or at least 98%.

Thus, according to an embodiment of the invention, essentially all the HCl in the hydrolyzate is removed and an essentially a HCl-free carbohydrate stream is formed by a combination of distillation operations ([C], [I], [(iv)] and [P]) with no need for other acid removal means, such as solvent extraction or membrane separation.

In some exemplary embodiments of the invention, the viscous fluid and/or the de-acidified solid carbohydrate composition comprise carbohydrate(s) resulting from the hydrolysis of the polysaccharides. According to an embodiment, the carbohydrates of the viscous fluid and/or of the de-acidified solid carbohydrate composition are of a low degree of polymerization, e.g. a combination of monosaccharides, disaccharides and oligosaccharides, e.g. trimers and or tetramers, at various ratios depending on the parameters of the hydrolysis reaction, such as HCl concentration, residence time and the like, and on the conditions used for the separation of the first separated HCl stream, for the separation of the second separated HCl stream, where applicable, and for HCl and water and second solvent distillation from the second evaporation feed and in the spray drier (where applicable). Unless otherwise indicated, the term oligosaccharide relates to dimers, trimers, tetramers and other oligomers up to a degree of polymerization of 10. According to an embodiment, essentially all the oligomers in said viscous fluid, in de-acidified solid carbohydrate composition, and/or in both are water soluble.

According to an embodiment, the oligosaccharides of the viscous fluid and/or of the de-acidified solid carbohydrate composition are composed of multiple sugars. According to another embodiment, the oligosaccharides are composed of glucose and at least one sugar selected from the group consisting of mannose, xylose, galactose, arabinose and fructose, optionally at least two, or three or four such sugars.

According to an embodiment, the viscous fluid, the de-acidified solid carbohydrate composition or both are further converted into products, optionally selected from the group consisting of biofuels, chemicals, food ingredients and the like. In some exemplary embodiments of the invention, said further conversion comprises at least one of final purification, hydrolysis, carbohydrates fraction, dilution, re-concentration, and the like. In some exemplary embodiments of the invention, said further conversion comprises oligomers hydrolysis, which hydrolysis uses according to various embodiment, at least one biological catalyst, at least one chemical catalysts and/or a combination of both. According to an embodiment, said conversion involves fermentation to form fermentation products. According to an embodiment, the viscous fluid or the de-acidified solid carbohydrate composition is diluted prior to or simultaneously with application of a biological catalyst or of a chemical catalyst, or prior to fermentation. According to an embodiment, the viscous fluid, the de-acidified solid carbohydrate composition and or diluted solution thereof is converted as such. Alternatively, the viscous fluid is first pre-treated. According to an embodiment, pre-treating comprises at least one of adding a component, i.e. a nutrient according to an embodiment, removing a component, i.e. an inhibitor according to an embodiment, oligomers hydrolysis and combinations thereof.

According to an embodiment, oligomers hydrolysis in the viscous fluid, the de-acidified solid carbohydrate composition and or diluted solution thereof involves chemical catalysis, biological catalysis or a combination of those. According to an embodiment, HCl is used as a chemical catalyst. According to a related embodiment, HCl is added for said catalysis, optionally from a process stream, such as the first separated HCl stream, the second separated HCl stream and from a third separated HCl stream. According to an alternative embodiment, said HCl-catalyzed hydrolysis is conducted prior to the removal of the residual HCl from the viscous fluid.

According to an embodiment, such chemically catalyzed oligomers hydrolysis is conducted at a temperature in the range between 50° C. and 130° C. According to another embodiment, the residence time for hydrolysis is between 1 min and 60 min.

According to an embodiment, the method further comprises the steps of diluting the viscous fluid to form a diluted fluid that comprises oligomers and HCl, hereinafter referred to as diluted fluid, and maintaining said diluted fluid at a temperature and for a residence time sufficient for the hydrolysis of at least 50% of said oligomers. According to an embodiment, carbohydrates concentration in said diluted fluid is in the range between 1% and 60%, as calculated by 100 times carbohydrate weight divided by the combined weights of the carbohydrate and water, between 2% and 50% or between 5% and 40%. According to an embodiment, between 10% wt and 80% wt of the carbohydrates in said diluted fluid are in the form or oligomers, e.g. dimers, timers, tetramers and or higher oligomers, optionally between 20% and 77%, or between 30% and 70%.

According to an embodiment, the diluting is conducted by mixing with a diluting liquid, optionally water or an aqueous solution. HCl concentration in the diluted fluid depends on its concentration in the viscous fluid and on its concentration in the diluting liquid. According to an embodiment, HCl concentration in the diluted fluid is in the range between 0.2% and 10%, as calculated by 100 times HCl weight divided by the combined weights of the carbohydrate and water, optionally between 0.03% and 8% or between 0.5% and 5%.

According to an embodiment, the HCl/carbohydrate w/w ratio in the diluted fluid is similar to that in the viscous fluid.

The temperature of maintaining the diluted fluid and the residence time at that temperature are matters of optimization by a person skilled in the art. It is well known that the higher the temperature the greater is the kinetics of hydrolysis of oligomers. At the same time, elevated temperatures and extended residence times increase the degradation of carbohydrates, e.g. to degradation products such as furfural and hydroxyl-methyl-furfural. The optimization is directed to achieving the desired degree of hydrolysis of oligomers with minimal degradation of carbohydrates. According to an embodiment, at least 50% of the oligomers in the diluted fluid are hydrolyzed, at least 80%, at least 90% or at least 95%.

According to an embodiment, the viscous fluid comprises the second solvent and the diluting results in the formation of an organic phase. According to one embodiment, the organic phase is separated prior to the maintaining to form a separated organic phase and a separated diluted fluid. According to another embodiment, the maintaining is conducted in the presence of the organic phase and the latter is separated after the maintaining to form a separated organic phase and a separated maintained diluted fluid. According to an embodiment, the separated organic phase comprises impurities present within the diluted fluid and/or impurities formed during the maintaining Separating such impurities-comprising organic phase improves the purity of the carbohydrates in the separated maintained diluted fluid.

According to another embodiment the method further comprises the steps of diluting the viscous fluid to form a diluted fluid and separating HCl from the diluted fluid by means selected from solvent extraction, membrane separation, ion-exchange and combinations thereof to form a de-acidified carbohydrates solution. According to an embodiment, the concentration of carbohydrates in the diluted fluid is in the range between 1% and 60%, as calculated by 100 times carbohydrate weight divided by the combined weights of the carbohydrate and water, between 2% and 50% or between 5% and 40%. According to an embodiment, HCl concentration in the diluted fluid is in the range between 0.2% and 10%, as calculated by 100 times HCl weight divided by the combined weights of the carbohydrate and water, between 0.03% and 8% or between 0.5% and 5%. According to an embodiment, the diluted fluid is maintained at a temperature and for a residence time sufficient for the hydrolysis of at least 50% of the oligomers and the separating of HCl from the diluted fluid is conducted simultaneously with the maintaining, after the maintaining or a combination thereof.

According to an embodiment, the separating HCl from the diluted fluid uses solvent extraction, which includes contacting with a selective extractant. According to an embodiment, the selective extractant comprises a water-immiscible amine. According to an embodiment, the contacting with the selective extractant forms the de-acidified carbohydrates solution and an acid-containing extractant. According to an embodiment, the acid-comprising extractant is contacted with a base, e.g. an aqueous solution of a base, whereby a regenerated extractant is formed. According to an embodiment, the regenerated extractant is reused for acid extraction from the diluted fluid.

According to an embodiment, the separating HCl from the diluted fluid involves membrane separation and the membrane separation uses anion-exchange membranes characterized by selective permeation of anions. According to an embodiment, the membrane separation involves electrodialysis in a multi-compartment system, so that a separated de-acidified carbohydrates solution is collected in part of the compartments and an aqueous solution of separated HCl is collected in others.

According to an embodiment, the separating HCl from the diluted fluid involves ion-exchange with an ion-exchanger. According to an embodiment, the ion-exchanger is an anion-exchanger, optionally in a free-base form.

According to an embodiment, the method further comprises the steps of diluting the viscous fluid to form the diluted fluid, neutralizing at least a fraction of the HCl in the diluted fluid to form a diluted fluid comprising a chloride salt and carbohydrates and optionally separating the salt from the carbohydrates by means selected from membrane separation, ion-exchange, chromatography and their combinations to form the de-acidified carbohydrates solution. According to an embodiment, carbohydrate concentration in the diluted fluid is in the range between 1% and 60%, as calculated by 100 times carbohydrate weight divided by the combined weights of the carbohydrate and water, between 2% and 50% or between 5% and 40%. According to an embodiment, HCl concentration in the diluted fluid is in the range between 0.2% and 10%, as calculated by 100 times HCl weight divided by the combined weights of the carbohydrate and water optionally between 0.03% and 8% or between 0.5% and 5%. According to an embodiment, the diluted fluid is maintained at a temperature and for a residence time sufficient for the hydrolysis of at least 50% of the oligomers and the neutralizing is conducted after the maintaining or a combination thereof. According to an embodiment, the diluting and the neutralizing are conducted simultaneously. According to an embodiment, the neutralization and the separating of the salt are conducted simultaneously.

The neutralization can be performed with any base. In some exemplary embodiments of the invention, neutralizing is performed with a base selected from the group consisting of hydroxides, carbonates or bicarbonates of sodium, potassium, ammonium, calcium, magnesium and combinations thereof.

Any method of selectively separating the chloride salt from the carbohydrate within the diluted solution is suitable for the described exemplary methods. According to an embodiment, the separating of the salt involves membrane separation and the membrane separation may use ion-exchange membranes characterized by selective permeation of ions. According to an embodiment, the membrane separation involves electrodialysis (ED) in a multi-compartment system, so that a separated, de-acidified, carbohydrate solution is collected in part of the compartments and an aqueous solution of a separated chloride salt is collected in others.

According to an embodiment, the separating of the salt involves chromatographic separation. According to an embodiment the chromatographic salt separation uses methods similar to the ones used in corn wet milling. According to an embodiment, the chromatographic separation is conducted in a simulated moving bed (SMB) or in a similar system.

According to an embodiment, the chromatographic salt separation is combined with fractionation of the carbohydrates in the diluted fluid.

According to an embodiment, only a fraction of the chloride salt is separated from the dilute fluid. According to another embodiment, no salt is separated and the dilute fluid contains carbohydrates and chloride salt is used as such, e.g. as a precursor for chemical conversion into products such as biofuels and monomers for the polymers industry.

According to the various embodiments, the further steps of separating or neutralizing HCl enable reaching low HCl concentrations in the de-acidified carbohydrates solution. Thus, according to the embodiments of the method, the weight/weight ratio of HCl to carbohydrates in the de-acidified carbohydrate solution is less than 0.03, less than 0.02 or less than 0.01.

According to an embodiment, oligomers hydrolysis involves enzymatic hydrolysis. According to an embodiment, hydrolysis uses at least one enzyme with cellulose hydrolysis activity, at least one enzyme with hemicellulose hydrolysis activity, at least one enzyme with 1-4 alpha bond hydrolysis activity, at least one enzyme with 1-6 alpha bond hydrolysis activity, at least one enzyme with 1-4 beta bond hydrolysis activity, at least one enzyme with 1-6 beta bond hydrolysis activity, and combinations thereof. According to an embodiment, enzymes capable of operating at temperatures greater than 40° C., greater than 50° C. or greater than 60° C. are used. According to an embodiment, enzymes capable of operating at a carbohydrates concentration greater than 25% wt, greater than 30% wt, or greater than 35% wt are used. According to an embodiment, at least one immobilized enzyme is used for oligomers hydrolysis. According to an embodiment, multiple enzymes of the above list are immobilized and used in the converting.

According to an embodiment, carbohydrates within the described viscous fluid according to embodiments of the invention, in the de-acidified carbohydrates solution or within a product of their dilution, are further converted in a simultaneous saccharification and fermentation. As used herein, the term simultaneous saccharification and fermentation means a treatment wherein oligomers hydrolysis and fermentation of the hydrolysis products, optionally combined with fermentation of oligomers, e.g. dimers and trimers, are conducted simultaneously. In some exemplary embodiments of the invention, the hydrolysis and the fermentation are conducted in the same vessel. According to an embodiment, the simultaneous saccharification and fermentation conversion uses at least one enzyme with cellulose hydrolysis activity, at least one enzyme with hemicellulose hydrolysis activity, at least one enzyme with 1-4 alpha bond hydrolysis activity, at least one enzyme with 1-6 alpha bond hydrolysis activity, at least one enzyme with 1-4 beta bond hydrolysis activity, at least one enzyme with 1-6 beta bond hydrolysis activity, and combinations thereof. According to an embodiment, at least one immobilized enzyme is used in the simultaneous saccharification and fermentation. According to an embodiment, multiple enzymes of the above list are immobilized and used in the converting. According to an embodiment, the fermentation is to form a renewable fuel, such as ethanol, butanol or a fatty acid ester or a precursor of a renewable fuel, such as iso-butanol, and the like. According to another embodiment, the fermentation is to form food or a feed ingredient, such as citric acid, lysine and mono-sodium glutamate, and the like. According to still another embodiment, the fermentation is to form an industrial product, such as, but not limited to, a monomer for the polymers industry, e.g. lactic acid, a chemical for use as such or a precursor of such chemical. According to the described exemplary method, hydrolysis forms the HCl-comprising lignin stream comprising lignin, HCl and water (<lg8> in FIG. 1). According to an embodiment of the invention, within the HCl-comprising lignin stream, HCl amount, concentration and purity are W8, C8 and P8, respectively. According to an embodiment of the invention, a major fraction of the HCl in the HCl reagent stream ends up in the HCl-comprising lignin stream, such that W8/W6 is greater than 30%, greater than 38% or greater than 45%. The exemplary method enables the recovery of essentially all the acid in that stream and obtaining it at a high concentration to minimize re-concentration costs. In some exemplary embodiments of the invention, HCl separation from the HCl-comprising lignin stream is done with no or with only a minimal wash with water.

According to an embodiment, the lignocellulosic feed further comprises an organic compound, e.g. tall oil, and the like, and a fraction of the organic compound ends up within the HCl-comprising lignin stream. According to a related embodiment, the HCl-comprising lignin stream is brought into contact with a fourth organic solvent, whereupon the organic compound selectively transfers to the fourth organic solvent to form an organic compound-depleted lignin stream and a second organic compound-carrying solvent. According to an embodiment, the second organic compound-carrying solvent has a commercial value as such. According to another embodiment, the method further comprises a step of recovering the fourth organic solvent and organic compound from the second organic compound-carrying solvent to form a separated organic compound and a regenerated fourth organic solvent. Various methods are suitable for such recovering, including distilling the fourth organic solvent and extracting it into another solvent, wherein the organic compound has limited miscibility. According to an embodiment, the organic compound is a tall oil.

According to an embodiment, a third organic solvent is used to extract organic compounds from the hydrolyzate, a fourth organic compound is used to extract organic compounds form the HCl-comprising lignin stream and the third organic solvent and the fourth organic solvent are of essentially the same composition. According to a related embodiment, the first organic compound-carrying solvent and the second organic compound-carrying solvent are combined to form a combined organic compound-carrying solvent and the organic compound is separated from the combined organic compound carrying solvent.

As used herein, the term of essentially the same composition for two components means that the two are composed of the same compound or isomers with similar properties in case each of those is composed of a single compound, or, in case of mixtures, that at least 50% wt. of the composition of one component is identical to at least 50% wt. of the composition of the other component. That is, by way of example, the case wherein the two components are mixtures of hydrocarbons, e.g. C6 to C9 hydrocarbons and wherein at least 50% wt. of each mixture is the same hydrocarbon, e.g. heptane. In some exemplary embodiments of the invention, the third organic solvent, the fourth organic solvent or both are selected from the group consisting of heptanes, octanes and nonanes, or heptanes. According to an embodiment, the method comprises a step of forming a second lignin stream from the HCl-comprising lignin stream, which second lignin stream is characterized by a lignin to water weight/weight ratio in the range between 0.1 and 2, between 0.3 and 1.8, between 0.5 and 1.5 or between 0.8 and 1.2. The second lignin stream is further characterized by HCl/water weight/weight ratio in the range of between 0.15 and 1, between 0.2 and 0.8, between 0.25 and 0.6, or between 0.3 and 0.5.

According to an embodiment, the forming of the second lignin stream from the HCl-comprising lignin stream comprises separating ([D] in FIG. 1) HCl from the HCl-comprising lignin stream to form a third separated HCl stream <3s9> wherein HCl amount, concentration and purity are W9, C9 and P9, respectively, and forming an HCl-depleted lignin stream <dl>. According to an embodiment, the separating comprises distillation and the third separated HCl stream is gaseous. According to an embodiment, at least a portion of the third separated HCl stream is used to form the recycled reagent HCl, e.g. by combining the third separated HCl stream with at least a portion of the first separated HCl stream.

In some exemplary embodiments of the invention the HCl streams of about azeotropic concentration, e.g. the second separated HCl stream, are combined with the HCl-comprising lignin stream prior to the separation of the third separated HCl stream, e.g. by distillation.

According to an embodiment, W9/W8 is greater than 0.1, greater than 0.2, greater than 0.3 or greater than 0.4. According to another embodiment, P9/P8 is greater than 1.1, greater than 1.2, greater than 1.3 or greater than 1.4. According to another embodiment, C9/C8 is greater than 1.8, greater than 2.0, greater than 2.5 or greater than 3.0.

According to an embodiment, the forming of the second lignin stream further comprises a step ([K] in FIG. 1) of separating HCl from the HCl-depleted lignin stream to form a fourth separated HCl stream <4s10> wherein the HCl amount is W10, and forming a further HCl-depleted lignin stream. According to an embodiment, W10/W8 is greater than 0.1, greater than 0.2, greater than 0.3 or greater than 0.4. According to an embodiment, the further HCl-depleted lignin stream forms the second lignin stream as such or after some modification. According to an embodiment, the separating HCl from the HCl-depleted lignin stream comprises at least one of filtration, press filtration, centrifugation, and the like. According to an embodiment, the filtration, press filtration or centrifugation forms a wet cake of relatively high dry matter content. The inventors have surprisingly found that the separating of residual aqueous HCl solution is markedly improved when conducted on the HCl-depleted lignin stream after separating the third separated HCl stream. In some exemplary embodiments of the invention, the dry matter contents of that formed cake is greater than 30% wt, greater than 35% wt, greater than 38% or greater than 40% wt.

According to an embodiment, the lignocellulosic feed further comprises an organic compound, e.g. tall oil, and a fraction of the organic compound ends up in the further HCl-depleted lignin stream and or in the second lignin stream. According to a related embodiment, that further HCl-depleted lignin stream and or the second lignin stream is brought into contact with a fifth organic solvent, whereupon the organic compound selectively transfers to the fifth organic solvent to form an organic compound-depleted lignin stream and a third organic compound-carrying solvent. According to an embodiment, the third organic compound-carrying solvent has a commercial value as such. According to another embodiment, the method further comprises a step of recovering the fifth organic solvent and the organic compound from the third organic compound-carrying solvent to form a separated organic compound and a regenerated fifth organic solvent. Various methods are suitable for such recovering, including distilling the fifth organic solvent and extracting it into another solvent, wherein the organic compound has limited miscibility. According to an embodiment, the organic compound is a tall oil. According to an embodiment, the fifth organic solvent is essentially of the same composition as the third organic solvent, as the fourth organic solvent or both. According to a related embodiment, the third organic compound-carrying solvent is combined with the first organic compound-carrying solvent, with the second organic compound-carrying solvent or with both to form a combination out of which the organic compound and the solvent are separated. According to an embodiment of the invention, the second lignin stream (<2l> in FIG. 1) is contacted ([(v)] in FIG. 1) with a first organic solvent <1os> to form a first evaporation feed <1ef>. According to the method, water, HCl and the first organic solvent are distilled ([(vi)] in FIG. 1) from the first evaporation feed at a temperature below 100° C. and at a pressure below 1 atm, whereupon a first vapor phase (<1vp> in FIG. 1) and a lignin composition ((<lc> in FIG. 1) are formed.

The first organic solvent forms a heterogeneous azeotrope with water. According to an embodiment of the invention, the solubility of the first organic solvent in water, as determined by combining an essentially pure solvent and de-ionized water, at 25° C. is less than 15% wt, less than 10% wt, less than 5% or less than 1%. According to another embodiment, the solubility of water in the first organic solvent, similarly determined, is less than 20% wt, less than 15% wt, less than 10% or less than 8%. According to another embodiment, in the heterogeneous azeotrope with water, the weight/weight ratio of the first organic solvent to water is in the range between 50 and 0.02, between 20 and 0.05, between 10 and 1, or between 5 and 0.2.

According to another embodiment, the first organic solvent is characterized by having a polarity related component of Hoy's cohesion parameter between 0 and 15, between 4 and 12 or between 6 and 10. According to still another embodiment, the first organic solvent is characterized by having a hydrogen bonding related component of Hoy's cohesion parameter between 0 and 20, between 1 and 15 or between 2 and 14.

According to still another embodiment, the first organic solvent has a boiling point at 1 atm in the range between 100° C. and 200° C., between 110° C. and 190° C., between 120° C. and 180° C. or between 130° C. and 160° C.

In some exemplary embodiments of the invention, the first organic solvent is selected from the group consisting of C5-C8 alcohols, C5-C8 chlorides and combinations thereof, including primary, secondary, tertiary and quaternary ones, aliphatic and aromatic ones and linear and branched ones, toluene, xylenes, ethyl benzene, propyl benzene, isopropyl benzene and nonane. As indicated, the evaporating in [(vi)] forms a lignin composition. The lignin composition of some exemplary embodiments comprises between 10% wt and 50% wt lignin, between 12% wt and 40% wt, between 14% wt and 30% wt or between 15% wt and 25% wt. Unlike carbohydrates in the viscous fluid, lignin concentration is presented herein on an “as is” basis. According to an embodiment, the lignin composition is essentially water free. According to another embodiment, the lignin composition comprises water, but at a concentration of less than 8% wt water, less than 5% wt, less than 3% wt or less than 1% wt. The lignin composition also comprises between 50% wt and 90% wt of a first solvent, between 60% wt and 88% wt, between 70% wt and 85% wt or between 72% wt and 82% wt on an “as is” basis. The lignin composition also comprises, according to some embodiments, HCl, and the HCl concentration is less than 10% wt, less than 8% wt, less than 6% wt or less than 4% wt (on an as is basis). According to another embodiment, the lignin composition further comprises at least one carbohydrate and the carbohydrate content is less than 5% wt, less than 4% wt, less than 3% wt or less than 2% wt (on an as is basis).

The majority of the lignin in the composition is insoluble in water, in hydrochloric acid solutions, and in the first solvent. According to one embodiment, the lignin composition comprises insoluble lignin dispersed in a liquid, optionally in a liquid solvent solution, which may contain a few percents of aqueous solution dispersed therein. According to another embodiment, the lignin composition comprises the wet cake, wherein the lignin is wetted by said liquid solution.

According to an embodiment, the lignin composition further comprises at least one of residual cellulose, a mineral salt and tall oils. In some exemplary embodiments of the invention, the ratio between the amount of water in the second lignin stream and the amount of the first organic solvent contacted with it in [(v)] is such that the solvent is found in the lignin composition at the end of the distillation. In some exemplary embodiments of the invention, the solvent/water ratio in the lignin composition is greater than the solvent/water ratio in the water-solvent heterogeneous azeotrope.

According to an embodiment of the invention, in the lignin composition the first organic solvent to water weight/weight ratio is R1, the first organic solvent forms a heterogeneous azeotrope with water, the first organic solvent/water weight/weight ratio in the azeotrope is R12 and R1 is greater than R12 by at least 10%, by at least 25%, by at least 40% or by at least 50%. According to still another embodiment, the first organic solvent/water weight/weight ratio in the first evaporation feed is R13, the first organic solvent to water weight/weight ratio in the azeotrope is R12 and R13 is greater than R12 by at least 10%, by at least 25%, by at least 40% or by at least 50%. According to an embodiment, the first organic solvent used to form the first evaporation feed is not pure, e.g. containing water and or HCl. According to a related embodiment, the used first organic solvent is recycled from another step in the process, e.g. from a condensate of a distillation step. In such case, R13 refers to the ratio between the solvent on a solutes-free basis and water. As indicated earlier, R12 may depend on the temperature of distillation, on its pressure and on the content of the other components in the evaporation feed, including HCl and carbohydrates. Thus, as in the case of distilling from the second evaporation feed, the solvent/water ratio in the first vapor phase may differ from that in the solvent-water binary system. In that case, R12 as used herein means the solvent/water ratio in the first vapor phase.

According to an embodiment, the method further comprises the steps of condensing the vapors in the first vapor phase (step [Q] in FIG. 1) to form two phases, a first organic solvent-rich one (<1osr> in FIG. 1) and a second water-rich one (<2wr> in FIG. 1), using the first organic solvent-rich phase in said contacting step [(v)] and using the second water-rich phase for generating the hydrolysis medium. Any method of condensing is suitable, optionally comprising cooling, pressure increase or both. Typically, the first organic solvent-rich phase also comprises water and HCl and the second water-rich phase also comprises solvent and HCl. Any method of separating the phases is suitable, e.g. decantation, and the like. The first organic solvent-rich phase is used in step [(v)] as is or after some treatment, e.g. removal of dissolved water, HCl or both. The second water-rich phase is used for regenerating the hydrolysis medium as is or after some treatment.

In some exemplary embodiments of the invention, the method comprises further treating the lignin composition to form a treated lignin composition (step [R] in FIG. 1). According to various embodiments, further treating comprises removal of residual HCl from the lignin composition, neutralization of the residual HCl therein, desolventization and additional purification. According to an embodiment, desolventization comprises centrifugation. According to a related embodiment, desolventization comprises contacting the solvent-wetted lignin cake with water whereby water displaces solvent from the solvent wetted cake, followed by centrifugation.

According to an embodiment, HCl concentration within the lignin composition, within the treated lignin composition (<tlc> in FIG. 1) or in both is less than 10,000 ppm, less than 5000 ppm, or less than 2000 ppm.

In some exemplary embodiments of the invention, the first organic solvent is of essentially the same composition as the second organic solvent. According to a related embodiment, the method for the production of carbohydrate comprises (i) providing a lignocellulosic material feed comprising a polysaccharide and lignin; (ii) hydrolyzing the polysaccharide in an HCl-comprising hydrolysis medium to form a first aqueous solution comprising carbohydrates, HCl and water, wherein the weight/weight ratio of carbohydrates to water is in the range between 0.4 and 3 and wherein the weight/weight ratio of HCl to water is in the range between 0.17 and 0.50; and a second lignin stream comprising lignin, HCl and water, wherein the weight/weight ratio of lignin to water is in the range between 0.1 and 2.0 and wherein the weight/weight ratio of HCl to water is in the range between 0.15 and 1; (iii) contacting the first aqueous solution with a second organic solvent to form a second evaporation feed, which solvent forms a heterogeneous azeotrope with water and is characterized by at least one of (a) having a polarity related component of Hoy's cohesion parameter between 0 and 15 MPa^{1/2}, (b) having a hydrogen bonding related component of Hoy's cohesion parameter between 0 and 20 MPa^{1/2}, and (c) having a solubility in water smaller than 15% wt, and forming a heterogeneous azeotrope with water, wherein the weight/weight ratio of the second organic solvent to water is in the range between 0.2 and 5, and wherein the solubility of water in the organic solvent is less than 20%; (iv) evaporating water, HCl and the second organic solvent from the second evaporation feed at a temperature below 100° C. and at a pressure below 1 atm, whereupon a second vapor phase and a viscous fluid as described above are formed; (v) diluting the viscous fluid to form a diluted fluid, (vi) treating the diluted fluid by at least one of separating HCl therefrom and neutralizing HCl therein to form a chloride salt, (vii) contacting the second lignin stream with the first organic solvent to form a first evaporation feed, and (viii) evaporating water, HCl and a first organic solvent from the first evaporation feed at a temperature below 100° C. and at a pressure below 1 atm, whereupon a first vapor phase and a lignin composition as described above are formed.

According to a related embodiment, the first vapor phase or its condensate(s) is combined with the second vapor phase or its condensate(s) for further treatment resulting in the formation of a water-rich phase to be used in regenerating the hydrolysis medium and an organic solvent-rich phase to be used in the contacting steps [(iii)] and [(v)].

In some embodiments, the method further comprises combining (step [S] in FIG. 1) at least portions of multiple HCl-comprising streams to reform the recycled HCl reagent stream. According to a related embodiment, the combining is of at least two HCl-comprising streams selected from the group consisting of the first separated HCl stream, the second separated HCl stream, the third separated HCl stream, the fourth separated HCl stream, the first water-rich phase, and the second water-rich phase. The amount, concentration and purity of HCl in the recycled HCl reagent stream are W6, C6 and P6, respectively. According to an embodiment, W6/W4 is greater than 1, at least 1.2, at least 1.5 or at least 1.8. According to an embodiment, the weight/weight ratio between W6 and that of the initial polysaccharide-comprising feed in forming the hydrolysis medium is between 0.2 and 5 or between 0.5 and 3. According to an embodiment, P6 is greater than 80%, greater than 85%, greater than 90% or greater than 95%. According to another embodiment, C6 is greater than 30%, greater than 35%, greater than 38% or greater than 40%, as calculated by 100 time HCl weight divided by the combined weights of HCl and water. In some exemplary embodiments of the invention, formation of the recycled HCl reagent stream does not require water removal from the HCl-comprising stream. According to another embodiment, water removal from the HCl-comprising stream is limited to less than 0.1 ton of water per one ton of HCl in the recycled HCl reagent stream, less than 0.05 ton, less than 0.03 ton or less than 0.01 ton.

While the invention will now be described in connection with certain embodiments in the following examples so that features thereof may be more fully understood and appreciated, the presented examples do not limit the invention to these particular embodiments. On the contrary, it is intended to cover all alternatives, modifications and equivalents as may be included within the scope of the invention as defined by the appended claims. Thus, the following examples which include exemplary embodiments will serve to illustrate the practice of this invention, it being understood that the particulars shown are by way of example and for purposes of illustrative discussion of exemplary embodiments only and are presented in the cause of providing what is believed to be the most useful and readily understood description of formulation procedures as well as of the principles and concepts of various exemplary embodiments of the invention.

### EXAMPLES

### Example 1

Preparation of the first aqueous solution glucose: HCl, water and glucose (CH) were mixed to form HCl/(HCl+water)=0.248 and CH/(CH+water)=0.64. The mixture was kept at 40° C. for 3 hours, in which time oligomers were formed.

33.6 gr of the first aqueous solution were combined in a flask with 8.2 gr hexanol to form an evaporation feed. Evaporation was applied at 100-150 mbar for about 0.5 hr at a temperature that increased from 62° C. at the beginning of the distillation to 76° C. at its end. The distillate was cooled and collected to form an organic solvent-rich light phase (light) and an aqueous phase (heavy). At the end of the distillation, two phases were observed in the flask—a small amount of a light one and a heavy viscous fluid. The four phases were weighed and analyzed. The viscous fluid was centrifuged for separation of the solvent prior to analysis. The solvent content there was less than 10% wt. The analysis of the viscous fluid on a solvent-free basis is presented in Table 1 as % wt. In addition, CH/(CH+water) and HCl/(HCl+water) there are presented:

TABLE 1
Viscous fluid analysis

| HCl | H₂O | CH | CH/ | HCl/ |
|---|---|---|---|---|
| Wt % | Wt % | Wt % | (CH + water) | (HCl + water) |
| 4.95 | 8.51 | 86.2 | 0.91 | 0.38 |

The formed viscous fluid had an HCl to carbohydrates weight/weight ratio of about 0.058, which represents HCl removal greater than 95% from a typical hydrolyzate, wherein HCl/carbohydrate weight/weight ratio is greater than 1. Its water/carbohydrate weight/weight ratio is about 10%, representing removal of about 95% of the water in the hydrolyzate, wherein the water/carbohydrate weight/weight ratio is greater than 2. The viscous fluid, as is, before the separation of the solvent, had a viscosity of about 80 cP at 80° C., low enough to be fed to a spray drier.

### Example 2

Preparation of the first aqueous solution: HCl, water, xylose and glucose (referred to together as carbohydrates, CH) were mixed to form HCl/(HCl+water)=0.22 and CH/(CH+water)=0.65. The mixture was kept overnight at 34° C.

33.4 gr of that first aqueous solution were combined in a flask with 8.0 gr hexanol to form an evaporation feed. Evaporation was applied at 100-150 mbar for about 1.5 hr at a temperature that increased from 62° C. at the beginning of the distillation to 75° C. at its end. The distillate was cooled and collected to form an organic solvent-rich light phase (light) and an aqueous phase (heavy). At the end of the distillation, two phases were observed in the flask—a small amount of a light one and a heavy viscous fluid. The four phases were weighed and analyzed. The viscous fluid was centrifuged for separation of the solvent prior to analysis. The solvent content was less than 10% wt. The analysis of the viscous fluid on a solvent-free basis is presented in Table 2 as % wt. In addition, CH/(CH+water) and HCl/(HCl+water) therein are also presented:

TABLE 2
Viscous fluid analysis

| | HCl | H₂O | CH | CH/ | HCl/ |
|---|---|---|---|---|---|
| Gr | Wt % | Wt % | Wt % | (CH + W) | (HCl + W) |
| 22.7 | 5.41 | 11.5 | 83 | 0.88 | 0.32 |

Acid and water removal in Exp. 2 are slightly lower than those in Exp. 1, and the same is true for the viscosity.

### Example 3

32.7 gr of the first aqueous solution formed in Example 1 were combined in a flask with 5.9 gr hexanol to form an evaporation feed. Evaporation was applied at 100-150 mbar for about 45 min at a temperature that increased from 62° C. at the beginning of the distillation to 72° C. at its end. The distillate was cooled and collected to form an organic solvent-rich light phase (light) and an aqueous phase (heavy). At the end of the distillation, two phases were observed in the flask—a small amount of a light one and a heavy viscous fluid. The four phases were weighed and analyzed. The viscous fluid was centrifuged for separation of the solvent prior to analysis. The solvent content was less than 10% wt. The analysis of the viscous fluid on a solvent-free basis is presented in Table 3 as % wt. In addition, CH/(CH+water) and HCl/(HCl+water) therein are also presented:

TABLE 3
Viscous fluid analysis

| | HCl | H₂O | CH | CH/ | HCl/ |
|---|---|---|---|---|---|
| Gr | Wt % | Wt % | Wt % | (CH + W) | (HCl + W) |
| 25.4 | 7.74 | 14.4 | 77.6 | 0.84 | 0.36 |

### Example 4

19.3 gr of the first aqueous solution formed in Example 1 were combined in a flask with 20.7 gr xylenes mixture to form an evaporation feed. Evaporation was applied at 100-150 mbar for about 1 hour at a temperature that increased from 65° C. at the beginning of the distillation to 69° C. at its end. The distillate was cooled and collected to form an organic solvent-rich light phase (light) and an aqueous phase (heavy). At the end of the distillation, two phases were observed in the flask—a small amount of a light one and a heavy viscous fluid. The four phases were weighed and analyzed. The viscous fluid was centrifuged for separation of the solvent prior to analysis. The solvent content was less than 15% wt. The analysis of the viscous fluid on a solvent-free basis is presented in Table 4 as % wt. In addition, CH/(CH+water) and HCl/(HCl+water) therein are also presented

TABLE 4
Viscous fluid analysis

| | HCl | H₂O | CH | CH/ | HCl/ |
|---|---|---|---|---|---|
| Gr | Wt % | Wt % | Wt % | (CH + W) | (HCl + W) |
| 20.9 | 5.67 | 12.6 | 79.0 | 0.86 | 0.41 |

Acid and water removal was similar to that for hexanol. The viscosity was also similar.

### Example 5

Preparation of the first aqueous solution glucose: HCl, water and carbohydrates mixture (CH) were mixed to form HCl/(HCl+water)=0.255 and CH/(CH+water)=0.66. The carbohydrates mixture contained glucose, fructose, xylose, arabinose and galactose at relative weights of 100, 1.25, 11.4, 3 and 4.8, respectively. The mixture was kept at 45° C. for 2 hours, in which time oligomers were formed.

32.4 gr of that first aqueous solution were combined in a flask with 6.23 gr hexanol to form an evaporation feed. Evaporation was applied at 100-150 mbar for about 0.5 hour at a temperature that increased from 63° C. at the beginning of the distillation to 68° C. at its end. The distillate was cooled and collected to form an organic solvent-rich light phase (light) and an aqueous phase (heavy). At the end of the distillation, two phases were observed in the flask—a small amount of a light one and a heavy viscous fluid. The four phases were weighed and analyzed. The viscous fluid was centrifuged for separation of the solvent prior to analysis. The solvent content was less than 10% wt. The analysis of the viscous fluid on a solvent-free basis is presented in Table 5 as % wt. In addition, CH/(CH+water) and HCl/(HCl+water) therein are also presented:

TABLE 5
Viscous fluid analysis

| | HCl | H2O | CH | CH/ | HCl/ |
|---|---|---|---|---|---|
| Gr | Wt % | Wt % | Wt % | (CH + W) | (HCl + W) |
| 25.8 | 7.0 | 14.9 | 77.8 | 0.84 | 0.33 |

The viscosity of the viscous phase here (including the solvent) was lower than that in previous examples, where a single carbohydrate or two carbohydrates were tested.

### Example 6

Preparation of the first aqueous solution glucose: HCl, water and glucose (CH) were mixed to form HCl/(HCl+water)=0.285 and CH/(CH+water)=0.66.

41.8 gr of the first aqueous solution were combined in a flask with 10.0 gr hexanol to form an evaporation feed. Evaporation was applied at 100-150 mbar for about 1.5 hr at a temperature that increased from 62° C. at the beginning of the distillation to 80° C. at its end. The distillate was cooled and collected to form an organic solvent-rich light phase (light) and an aqueous phase (heavy). At the end of the distillation, two phases were observed in the flask—a small amount of a light one and a heavy viscous fluid. The four phases were weighed and analyzed. The viscous fluid was centrifuged for separation of the solvent prior to analysis. The solvent content therein was less than 10% wt. The analysis of the viscous fluid on a solvent-free basis is presented in Table 6 as % wt. In addition, CH/(CH+water) and HCl/(HCl+water) therein are also presented

TABLE 6
Viscous fluid analysis

| HCl | H₂O | CH | CH/ | HCl/ |
|---|---|---|---|---|
| Wt % | Wt % | Wt % | (CH + water) | (HCl + water) |
| 34.6 | 6.0 | 86.2 | 0.91 | 0.41 |

### Example 7

Preparation of the lignin solution: 18.77 gr lignin, 18.14 gr HCl and 60.28 gr water were mixed. The solution was combined in a flask with 243.2 gr of fresh hexanol. Distillation was applied at atmospheric pressure at about 102-103° C. for 3 hours. The distillate was cooled and collected to form an organic solvent-rich light phase (light) and an aqueous phase (heavy). In the feed flask remained a lignin cake in a brown liquid, rich in solvent.

The cake was filtered and analyzed. The DS of the cake was about 38%, the hexanol content was about 60%, and the HCl content, on as is basis, was about 0.7%. It will be understood by those skilled in the art that various changes in form and details may be made herein without departing from the spirit and scope of the invention as set forth in the appended claims. Those skilled in the art will recognize, or be able to ascertain using no more than routine experimentation, many equivalents to the specific embodiments of the invention described herein. Such equivalents are intended to be encompassed in the scope of the claims. In the claims articles such as “a,”, “an” and “the” mean one or more than one unless indicated to the contrary or otherwise evident from the context. Claims or descriptions that include “or” or “and/or” between members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides, in various embodiments, all variations, combinations, and permutations in which one or more limitations, elements, clauses, descriptive terms, etc., from one or more of the listed claims is introduced into another claim dependent on the same base claim unless otherwise indicated or unless it would be evident to one of ordinary skill in the art that a contradiction or inconsistency would arise. Where elements are presented as lists, e.g., in Markush group format or the like, it is to be understood that each subgroup of the elements is also disclosed, and any element(s) can be removed from the group. It should it be understood that, in general, where embodiment(s) of the invention is/are referred to as comprising particular elements, features, etc., certain embodiments of the invention consist, or consist essentially of, such elements, features, etc. For purposes of simplicity those embodiments have not in every case been specifically set forth in haec verba herein. Certain claims are presented in dependent form for the sake of convenience, but Applicant reserves the right to rewrite any dependent claim in independent format to include the elements or limitations of the independent claim and any other claim(s) on which such claim depends, and such rewritten claim is to be considered equivalent in all respects to the dependent claim in whatever form it is in (either amended or unamended) prior to being rewritten in independent format.

What is claimed is:

1. A viscous fluid comprising between 2% wt and 25% wt water, at least 75% wt carbohydrate, as calculated by 100 times carbohydrate weight divided by the combined weights of the carbohydrate and water, between 0% wt and 25% wt of a second organic solvent and between 10% wt and 55% wt HCl, as calculated by 100 times HCl weight divided by the combined weights of HCl and water, which second organic solvent is characterized by at least one of:
(a2) having a polarity related component of Hoy's cohesion parameter between 0 and 15 MPa^{1/2};
(b2) having a Hydrogen bonding related component of Hoy's cohesion parameter between 0 and 20 MPa^{1/2}; and
(c2) having a solubility in water of less than 15% and forming a heterogeneous azeotrope with water,
wherein the weight/weight ratio of said second organic solvent to water is in the range of between 50 and 0.02, and wherein the solubility of water in said organic solvent is less than 20%.

2. The viscous fluid according to claim 1, wherein the viscosity of said viscous fluid as measured at 80° C. by the Brookfield method is less than 150 cP.

3. The viscous fluid according to claim 1, wherein the weight/weight ratio of HCl to water is in the range between 0.2 and 1.0.

4. The viscous fluid according to claim 1, wherein the weight/weight ratio of carbohydrate to water is in the range between 2 and 20.

5. The viscous fluid according to claim 1, wherein the weight/weight ratio of HCl to carbohydrate is in the range between 0.02 and 0.15.

6. The viscous fluid according to claim 1, wherein the weight/weight ratio of the second organic solvent to water in said viscous fluid is R2, wherein the second organic solvent forms said heterogeneous azeotrope with water and the weight/weight ratio of said second organic solvent to water in said azeotrope is R22 and wherein R2 is greater than R22 by at least 10%.

7. The viscous fluid according to claim 1, wherein the second organic solvent forms said heterogeneous azeotrope with water, wherein said second organic solvent has a boiling point at 1 atm in the range of between 100° C. and 200° C. and wherein said heterogeneous azeotrope has a boiling point at 1 atm of less than 100° C.

8. The viscous fluid according to claim 1, whenever said viscous fluid is maintained under a pressure of less than 400 mbar.

9. The viscous fluid according to claim 1, wherein said carbohydrate comprises glucose and at least one carbohydrate selected from the group consisting of mannose, galactose, xylose, arabinose, and fructose.

10. The viscous fluid according to claim 9, wherein said carbohydrate comprises at least two carbohydrates selected from said group.

11. A method for the deacidification of a first aqueous solution comprising the steps of:
(i) providing a first aqueous solution comprising carbohydrates, HCl and water, wherein the weight/weight ratio of carbohydrates to water is in the range of between 0.4 and 3 and wherein the weight/weight ratio of HCl to water is in the range between 0.17 and 0.50;
(ii) contacting said first aqueous solution with a second organic solvent to form a second evaporation feed, which second organic solvent forms a heterogeneous azeotrope with water and is characterized by at least one of:
(a2) having a polarity related component of Hoy's cohesion parameter between 0 and 15 MPa^{1/2};
(b2) having a hydrogen bonding related component of Hoy's cohesion parameter between 0 and 20 MPa^{1/2}; and
(c2) having a solubility in water of less than 15%, and forming said heterogeneous azeotrope with water,
wherein the weight/weight ratio of said second organic solvent to water is in the range of between 50 and 0.02, and wherein the solubility of water in said organic solvent is less than 20%, and
(iii) evaporating water, HCl and said second organic solvent from said second evaporation feed at a temperature below 100° C. and at a pressure below 1 atm, whereupon a second vapor phase and a viscous fluid according to claim 1 is formed.

12. The method according to claim 11, wherein providing said first aqueous solution comprises hydrolyzing a polysaccharide-comprising material in an HCl-comprising hydrolysis medium, wherein HCl concentration is greater than azeotropic.

13. The method according to claim 12, further comprising the steps of condensing the vapors in said second vapor phase to form two phases, a second organic solvent-rich one and a first water-rich one, separating said phases, using said second organic solvent-rich phase in step (ii) and using said first water-rich phase for generating said hydrolysis medium.

14. The method according to claim 11, wherein said viscous solution comprises carbohydrate oligomers, and further comprising the steps of diluting said viscous fluid to form a diluted fluid and maintaining said diluted fluid at a temperature and for a residence time sufficient for the hydrolysis of at least 50% of said oligomers.

15. The method according to claim 11, further comprising the steps of diluting said viscous fluid to form a diluted fluid and separating HCl from said diluted fluid by one or more means selected from the group consisting of solvent extraction, membrane separation and ion-exchange and.

16. The method according to claim 11, further comprising the steps of diluting said viscous fluid to form a diluted fluid, neutralizing at least a fraction of the HCl in said diluted fluid to form a diluted fluid comprising a chloride salt and carbohydrates and separating said salt from said carbohydrates by means selected from membrane separation and chromatography to form a de-acidified carbohydrates solution.

17. The method according to claim 15, wherein the weight/weight ratio of HCl to carbohydrates after said separating HCl is less than 0.03.

18. The method according to claim 16, wherein the weight/weight ratio of HCl to carbohydrates in said de-acidified carbohydrate solution is less than 0.03.

19. A hetero-oligosaccharides composition comprising tetramers composed of glucose and at least two sugars selected from the group consisting of mannose, xylose, galactose, arabinose and fructose.

20. A method comprising:
(i) contacting an initial volume of solution comprising carbohydrates, HCl and water with a second organic solvent to form a second evaporation feed wherein said second organic solvent forms a heterogeneous azeotrope with water has a polarity related component of Hoy's cohesion parameter between 0 and 15 MPa^{1/2} and/or has a hydrogen bonding related component of Hoy's cohesion parameter between 0 and 20 MPa^{1/2} and has a solubility in water of less than 20%;
(ii) evaporating water, HCl and said second organic solvent from said second evaporation feed at a temperature below 100° C. and at a pressure below 1 atm, to produce a smaller volume of a viscous fluid according to claim 1; and
(iii) spray drying said smaller volume.

21. A method according to claim 20 comprising, preparing said an initial volume of solution comprising carbohydrates, HCl and water by:
hydrolyzing a polysaccharide-comprising feed in an HCl-comprising hydrolysis medium to produce a hydrolyzate;
separating ≧50% of the HCl and ≧50% of the water from the hydrolyzate to produce said initial volume of solution.
